(19) United States
(12) Patent Application Publication
(10) Pub. No.: US 2014/0052383 A1
(43) Pub. Date: Feb. 20, 2014

(54) SYSTEMS AND METHODS FOR IDENTIFYING A CONTRIBUTOR'S STR GENOTYPE BASED ON A DNA SAMPLE HAVING MULTIPLE CONTRIBUTORS

(71) Applicants: Brons LARSON, San Diego, CA (US); Robert Schreiner, San Diego, CA (US)

(72) Inventors: Brons LARSON, San Diego, CA (US); Robert Schreiner, San Diego, CA (US); Clifford Tureman Lewis, San Diego, CA (US)

(21) Appl. No.: 13/529,805

(22) Filed: Jun. 21, 2012

Related U.S. Application Data
(60) Provisional application No. 61/499,965, filed on Jun. 22, 2011.

(51) Int. Cl. G06F 19/22

(52) U.S. Cl. CPC G06F 19/22
USPC 702/20

(57) ABSTRACT

Under one aspect of the present invention, a method is provided for analyzing a mixture of DNA from two or more contributors, to identify at least one contributor's STR genotypes at a plurality of STR loci. Possible solutions may be determined independently for each STR locus, each solution including the number of contributors, an STR genotype for each contributor at that locus, an abundance ratio of their respective contributions, and a confidence score. The most likely solutions for the STR locus having the highest confidence score then are used as givens, based upon which the solutions for the other STR loci may be sequentially obtained, in each instance using as givens the most likely solutions for any previously analyzed loci. STR genotypes are output that share as givens the number of contributors and the abundance ratio used in the most likely solution for the last analyzed STR locus.

### CROSS-REFERENCE TO RELATED APPLICATIONS

This application claims the benefit of U.S. Provisional Patent Application No. 61/499,965, filed Jun. 22, 2011, which is incorporated by reference herein in its entirety.

### FIELD OF INVENTION

This application relates to systems and methods for identifying a contributor's short tandem repeat (STR) genotype based on a deoxyribonucleic acid (DNA) sample having multiple contributors.

### BACKGROUND OF INVENTION

In recent years, technology has been developed to identify individuals based on their respective genotypes, for example, based on the particular sequences of base pairs known as short tandem repeats (STRs) that appear at known loci, or specific positions, in the individuals' DNA sequence. As is known in the art, an STR is a pattern of two or more nucleotides that repeats, e.g., (CATG)ₙ where n is the number of repeats, and that occurs at a particular STR locus. Different particular sequences are repeated at the different STR loci, but individuals differ at each locus only in the number of repeats of the particular genetic sequence that is repeated at that locus, the number of repeats defining an “allele.” Additionally, at a given STR locus each individual has at most two possible alleles, or particular number of repeats of the genetic sequence, one sequence being contributed by the individual's father and the other by the individual's mother. If the two alleles are the same (e.g., both alleles have 8 repeats), the individual is defined as having homozygous alleles at that STR locus, and if the two alleles are different (e.g., one allele has 8 repeats and the other has 15 repeats), the individual is defined as having heterozygous alleles at that locus. The number of repeats of each of the alleles at an STR locus thus provides an identity of the individual's allele(s) at that locus, which in turn defines the individual's STR genotype at that locus.

Although a given individual may have the same STR genotype as another individual at a single STR locus, it is statistically unlikely that those two individuals would have the same overall STR genotypes as one another across even a few loci, let alone across ten or more loci, with the likelihood of a match decreasing as the number of loci at which those individuals' STR genotypes are compared increases. As such, an individual's STR genotypes across a sufficient number of STR loci may be used as a “genetic fingerprint” that essentially uniquely identifies that individual. For further details, see, for example, Perlin et al., “An Information Gap in DNA Evidence Interpretation,” PLOS ONE 4(12) e8327, pages 1-12, which is incorporated by reference herein in its entirety.

However, it has been computationally difficult—if not computationally intractable—to identify an individual's STR genotype at a plurality of loci based on a DNA sample having DNA contributions from multiple individuals. For examples of previous efforts to identify STR genotypes based on such mixed DNA mixtures, see, e.g., U.S. Pat. No. 6,807,490 to Perlin, U.S. Pat. No. 7,162,372 to Wang et al., U.S. Pat. No. 7,860,661 to Wang, and U.S. Patent Publication No. 2010/0198522 to Tvedebrink et al., each of which is incorporated by reference herein in its entirety.

### SUMMARY OF INVENTION

Embodiments of the present invention provide systems and methods for identifying a contributor's short tandem repeat (STR) genotype based on a deoxyribonucleic acid (DNA) sample having multiple contributors.

Under one aspect of the present invention, a method is provided for analyzing a mixture of DNA from two or more contributors to identify the STR genotypes of at least one of said contributors at a plurality of STR loci. The method may include (a) for each STR locus in said plurality of STR loci, independently determining a plurality of possible solutions for said STR locus and the confidence score for each of the possible solutions given data characterizing the relative abundances and sizes of STRs in said mixture at that locus. Each solution may include (i) a defined number N of contributors, (ii) a defined STR genotype for each of the N contributors at that locus, and (iii) a defined abundance ratio of respective contributions from the N contributors. The method further may include (b) for the STR locus having the highest confidence score, selecting one or more possible solutions for that locus that have a likelihood above a threshold value. The method further may include (c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value. The method further may include (d) repeating step (c) serially for each remaining STR locus in descending order of confidence score given the defined number N and the defined abundance ratio of the possible solutions for the immediately previously analyzed STR locus. The method further may include (e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

In some embodiments, the method further includes obtaining the defined number N of contributors prior to executing step (a). The defined number N of contributors may be obtained based on population statistics. The method may further include (f) obtaining a new defined number N′ of contributors; (g) repeating steps (a) through (d) given the new defined number N′ of contributors; and (h) outputting the STR genotype for the most likely selected solution of step (g) for the last STR locus analyzed and the STR genotype for each selected solution for each previously analyzed STR locus that shares as a given the new defined number N′ of contributors and the defined abundance ratio used to determine the most likely selected solution of step (g) for the last STR locus. In some embodiments, the defined number N of contributors is obtained by determining how many STRs are present in the data at each locus, and by defining the number N of contributors to be the minimum number of individuals who could have contributed to the DNA sample given how many STRs are present in the data at the locus having the most STRs in the data.

In some embodiments, step (a) comprises: (i) defining a range of hypothetical abundance ratios of contributions of the defined number N of contributors; (ii) for each STR locus, defining a set of hypothetical STR genotypes at that locus that is consistent with the defined number N of contributors and with the data characterizing the sizes of the STRs at that locus; and (iii) for each STR locus, determining the plurality of possible solutions based on the set of hypothetical STR genotypes for that locus defined in step (a)(ii) and in the different hypothetical abundance ratios defined in step (a)(i). In some embodiments, step (a) further comprises: (iv) for each STR locus, comparing each solution from step (a)(iii) for that locus to the data characterizing the abundances and sizes of the STRs at that locus to obtain the likelihood of that solution; and (v) for each STR locus, analyzing the likelihoods of the solutions for that locus to obtain the confidence score of that STR locus. In some embodiments, analyzing the likelihoods of the solutions in step (a)(v) comprises obtaining a likelihood ratio for each solution by dividing the likelihood of that solution by the likelihood of the next most likely solution. In other embodiments, analyzing the likelihoods of the solutions in of step (a)(v) comprises determining the sparsity of the distribution of likelihoods for each locus. In still other embodiments, analyzing the likelihoods of the solutions in of step (a)(v) comprises determining the kurtosis of the distribution of likelihoods for each locus.

In some embodiments, each contributor has an unknown STR genotype prior to performing said method. In some embodiments, a mixture of DNA from two to four human contributors is analyzed. In some embodiments, two, three, or four of the human contributors have unknown STR genotypes prior to performing said method. In some embodiments, a mixture of DNA from three or four human contributors is analyzed. In some embodiments, three or four of the human contributors have unknown STR genotypes prior to performing said method. In some embodiments, a mixture of DNA four human contributors is analyzed. In some embodiments, each of the four human contributors have unknown STR genotypes prior to performing said method.

In some embodiments, the possible solutions determined in step (a) comprise solutions for each separate instance of N being 2, 3, or 4.

In some embodiments, the possible solutions for each locus are constrained by the sizes of STRs in said mixture at that locus.

In some embodiments, the STR genotype output in step (e) comprises the STR genotypes for the contributor that has the most abundant DNA in said mixture.

Some embodiments further include outputting the likelihood for said outputted STR genotypes.

Some embodiments further include (i) comparing the outputted STR genotypes to a database storing sets of STR genotypes present in human individuals and the identities of the corresponding individuals and (ii) outputting the identity of the human individual whose set of STR genotypes is most likely to match the outputted STR genotypes.

Under another aspect of the present invention, a computer-based system is configured to identify at least one individuals' STR genotype at a plurality of loci in a DNA sample having a mixture of a plurality of individuals' STR genotypes at the plurality of loci. The computer-based system may include a processor; a display device in operable communication with the processor; and a computer-readable storage medium in operable communication with the processor, the computer-readable storage medium configured to store instructions for causing the processor to execute the following steps: (a) for each STR locus in said plurality of STR loci, independently determining a plurality of possible solutions for said STR locus and the confidence score for each of the possible solutions given data characterizing the relative abundances and sizes of STRs in said mixture at that locus, each solution comprising: (i) a defined number N of contributors, (ii) a defined STR genotype for each of the N contributors at that locus, and (iii) a defined abundance ratio of respective contributions from the N contributors; (b) for the STR locus having the highest confidence score, selecting one or more possible solutions for that locus that have a likelihood above a threshold value; (c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value; (d) repeating step (c) serially for each remaining STR locus in descending order of confidence score given the defined number N and the defined abundance ratio of the possible solutions for the immediately previously analyzed STR locus; and (e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

Under another aspect of the present invention, a computer-readable medium is configured for use by a computer-based system to identify at least one individuals' STR genotype at a plurality of loci in a DNA sample having a mixture of a plurality of individuals' STR genotypes at the plurality of loci, the computer-based system comprising a processor, and a display device in operable communication with the processor. The computer-readable medium may include instructions for causing the processor to execute the following steps: (a) for each STR locus in said plurality of STR loci, independently determining a plurality of possible solutions for said STR locus and the confidence score for each of the possible solutions given data characterizing the relative abundances and sizes of STRs in said mixture at that locus, each solution comprising: (i) a defined number N of contributors, (ii) a defined STR genotype for each of the N contributors at that locus, and (iii) a defined abundance ratio of respective contributions from the N contributors; (b) for the STR locus having the highest confidence score, selecting one or more possible solutions for that locus that have a likelihood above a threshold value; (c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value; (d) repeating step (c) serially for each remaining STR locus in descending order of confidence score given the defined number N and the defined abundance ratio of the possible solutions for the immediately previously analyzed STR locus; and (e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

Under an alternative aspect of the present invention, a method for deconvolving individual simple tandem repeat (STR) genotypes from DNA samples containing multiple contributors comprises (a) estimating the likely numbers of contributors and a preliminary mixture ratio for each likely number of contributors; (b) for a first likely number of contributors, separately analyzing each STR locus to obtain a genotype hypothesis score and mixture ratio having the highest likelihood ratio (LR) score; (c) ranking the loci in descending order of LR score; (d) starting with the highest ranking locus that has not yet been included, process each locus one at a time in descending order of LR score, the processing for each locus comprising obtaining the most likely solution for that locus fixing the solutions for all previously processed loci, if any; (e) repeating steps (b) through (d) for other likely numbers of contributors, if any; and (f) returning the number of contributors, those contributors' STR genotypes, the mixture ratio, and the confidences for the solution with the highest overall likelihood.

Note that the terms “simple tandem repeat” and “short tandem repeat” may be used interchangeably herein, and in the art.

### BRIEF DESCRIPTION OF DRAWINGS

FIG. 1 illustrates an overview of steps in a method for identifying a contributor's STR genotype based on a DNA sample having multiple contributors, according to some embodiments of the present invention.

FIGS. 2A-2C illustrate exemplary STR traces at a given locus for DNA samples respectively obtained from different individuals.

FIGS. 2D-2E illustrate exemplary STR traces at the same locus as in FIGS. 2A-2C, for DNA samples having varying different abundance ratios of contributions from the individuals in FIGS. 2A-2C.

FIG. 2F illustrates an exemplary STR trace at the same locus as in FIGS. 2A-2E, for a DNA sample having a mixture of contributions from unknown number of unknown individuals, in an unknown abundance ratio.

FIG. 3A illustrates steps in a method of determining and evaluating possible solutions for each STR locus in a plurality of STR loci and selecting based on these solutions the highest information locus, the most likely solutions for which are to be used as givens, i.e., as fixed constraints, in the analysis of the remaining STR loci, according to some embodiments of the present invention.

FIGS. 3B-3C illustrate exemplary distributions of confidence scores for possible solutions that may be determined using the method illustrated in FIG. 3A.

FIG. 4 illustrates steps in a method for obtaining STR genotypes for contributors across a plurality of STR loci based on the most likely solution(s) for the highest information locus selected in FIG. 3, according to some embodiments of the present invention.

FIG. 5 illustrates steps in an alternative method for identifying genotypes in a sample having a mixture of genotypes of a plurality of individuals and in which the identity of at least one individual is known, according to some embodiments of the present invention.

FIG. 6 illustrates an exemplary computer-based system configured to execute the methods of FIGS. 1 and 3-5, according to some embodiments of the present invention.

FIGS. 7A-7D illustrate an exemplary user interface that may be displayed during use of the computer-based system of FIG. 6 and that includes an output area for displaying STR genotypes obtained using the methods of FIGS. 1 and 3-5, according to some embodiments of the present invention.

FIG. 8 illustrates steps in a method for implementing an alternative embodiment of the present invention.

### DETAILED DESCRIPTION

Embodiments of the present invention provide systems and methods for identifying a contributor's STR genotype based on a DNA sample having multiple contributors. Specifically, embodiments of the present invention provide a computationally feasible technique for analyzing STR data for DNA samples that contain contributions from multiple individuals so as to obtain the STR genotypes of some or all of such individuals. Note that individuals whose DNA is present in the mixture may be referred to herein as “contributors.” Two, three, four, five, six, seven, eight, nine, ten, or even more contributors may have contributed to the DNA sample, the identities of some or all of the contributors may be unknown prior to the analysis, and the ratio of their various contributions to the sample also may be unknown prior to the analysis. Thus, the present invention provides a powerful new basis for analyzing DNA samples.

Specifically, and as described in greater detail below, embodiments of the present invention deconvolve the different contributors' STR genotypes from one another using a “greedy” computational algorithm that begins by identifying a single STR locus having the highest information content, i.e., that locus from which the most information about the contributors may be learned. Preferably, the algorithm identifies this highest information STR locus by independently obtaining all possible solutions at all loci, determining the likelihood of each solution by comparing it to the data for the corresponding STR locus, obtaining a confidence score for each locus based on the distribution of likelihoods of solutions for that locus, and defining the locus having the highest confidence score to be the highest information STR locus. The algorithm then selects the most likely solutions for the highest information STR locus, each solution including a defined number of contributors, a defined STR genotype for each of those contributors, and a defined abundance ratio of respective contributions from the contributors, e.g., by comparing the likelihood of each of those solutions to a threshold value.

Then, the algorithm fixes a first one of the most likely solutions for the highest information STR locus, i.e., treats the number of contributors, their STR genotypes at the highest information STR locus, and the abundance ratio of this first solution as “givens,” or fixed constraints, based upon which the algorithm then determines the possible solutions at the next highest information content locus. Because the number of contributors and the abundance ratios are given, the possible solutions for this next highest information STR locus vary only in the STR genotypes of those contributors and not in the number of contributors or their abundance ratios. As such, the computational effort required to obtain such solutions are reduced relative to those for the highest information locus. The algorithm then selects which of those possible solutions is the most likely, and determines the possible solutions at the next highest information STR locus given this possible solution. The algorithm then sequentially repeats this process at the other STR loci, preferably in sequence of descending confidence score, to obtain an STR genotype based not only on the first solution at the highest information STR locus, but also based on solutions of all previously analyzed loci. As such, the selected solution for the last analyzed STR locus represents the most likely solution across all of the loci given the number of contributors and abundance ratio of the first one of the most likely solutions for the highest information STR locus.

However, the first solution for the highest information STR locus, based upon which the most likely solutions for the other STR loci are determined, is not necessarily the “true” solution (i.e., the solution that matches the actual contributors' STR genotype) but is only one likely solution. As such, the algorithm repeats the above-described process for the other most likely solutions for the highest information locus, in each case determining the most likely solution across all of the loci given the number of contributors and abundance ratio of a selected one of the most likely solutions for the highest information locus. However, the set of most likely solutions for the highest information locus, based upon which the most likely solutions for the other STR loci are determined, may not necessarily include the “true” solution. For example, the most likely solutions for the highest information STR locus may be based on an incorrect number of contributors, so the abundance ratios for those solutions may be incorrect, so the solutions that subsequently are determined for other STR loci, given the incorrect number of contributors and the incorrect abundance ratios, are unlikely to include the “true” solution. As such, the algorithm may repeat the entire above-described process for different numbers of contributors, e.g., identifying a highest information STR locus by independently determining all possible solutions at all loci given a different number of contributors, and then determining the most likely solutions at the other STR loci given the most likely solutions for the highest information locus.

As such, the algorithm efficiently searches among the most likely solutions for each of the STR loci by using as a “seed” the most likely solutions for the highest information STR locus. The algorithm then determines which one of these solutions is the most likely to be correct across all of the STR loci, and based on this determination outputs the STR genotype of each contributor. Such output thus provides an accurate “genetic fingerprint” of each contributor to the sample, which may be used to positively identify the contributors based on their STR genotypes.

First, an overview of the inventive method will be provided with reference to exemplary STR genotypes of contributors, and mixtures thereof. Then, further detail on individual steps of that method, and alternative embodiments thereof, will be provided. An exemplary computer-based system configured to implement the inventive method then will be described. Lastly, a set of examples illustrating the application of the present invention to a simulated DNA sample will be described.

Overview of Method 100

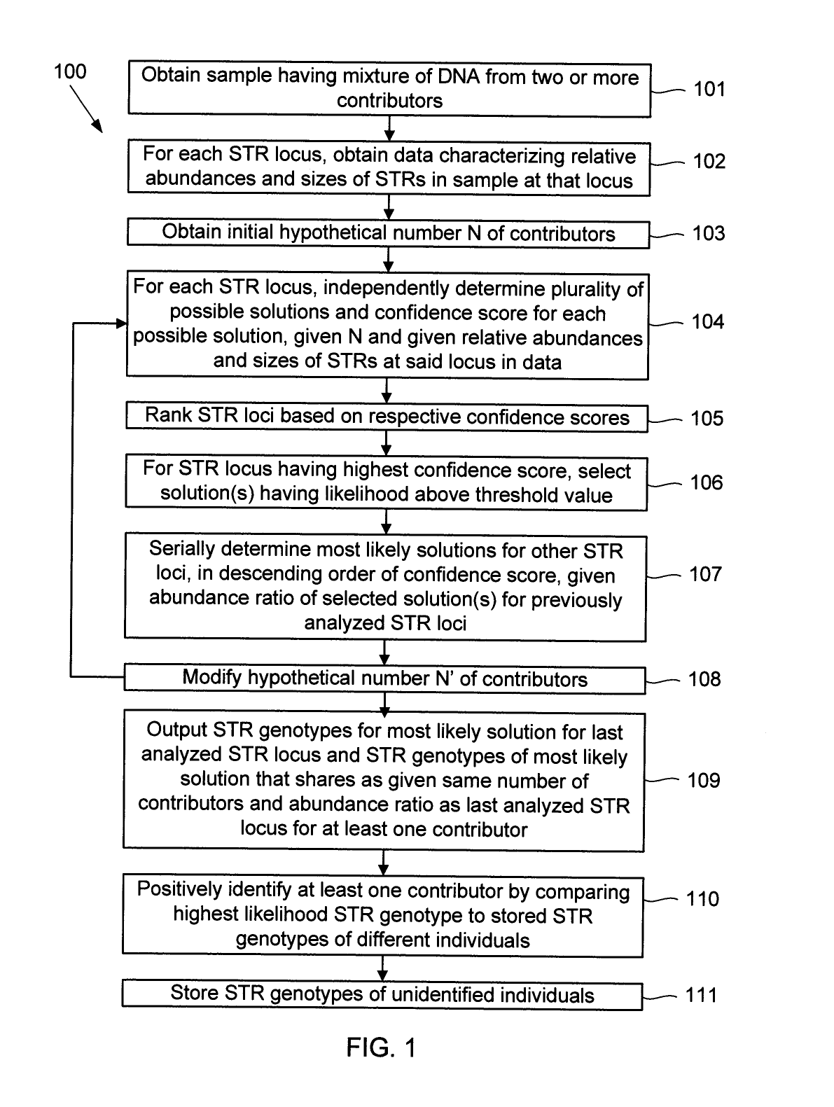

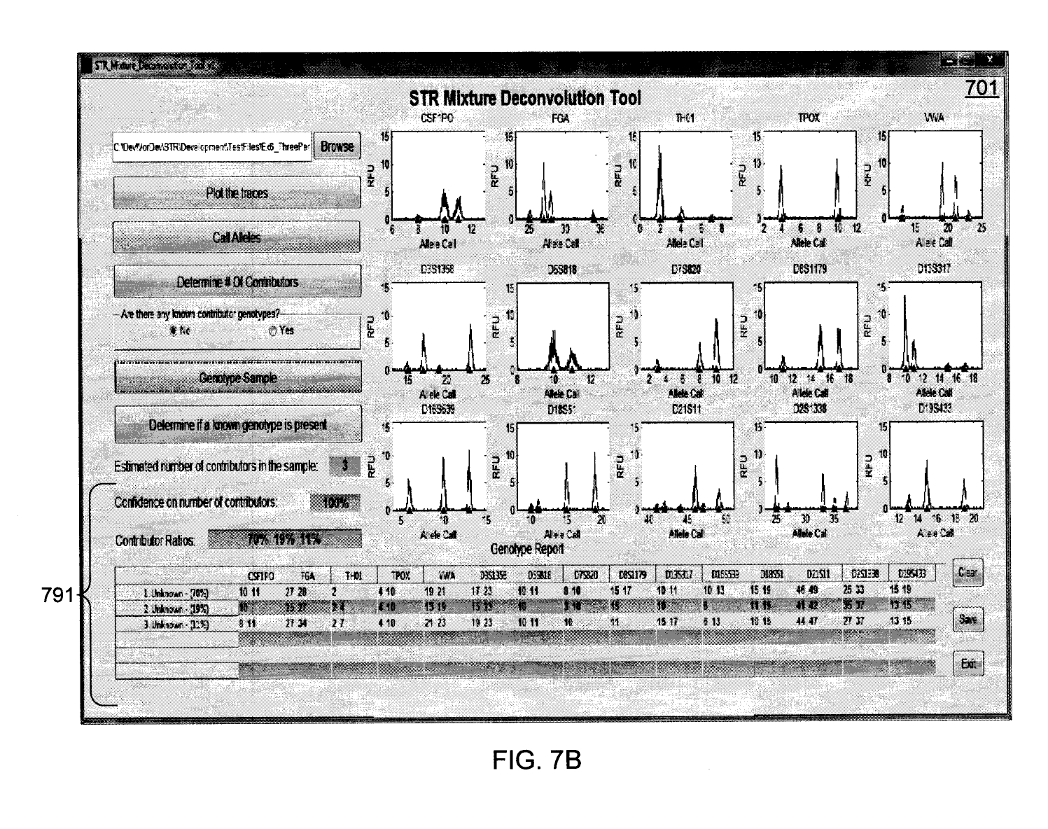

FIG. 1 illustrates steps in method 100 for deconvolving, or separating from one another, STR genotypes of contributors to a DNA sample, according to some embodiments of the present invention. Method 100 begins with obtaining a DNA sample having a mixture of DNA from two or more contributors (step 101). Such a sample may be collected, for example, as evidence at a crime scene using known techniques. The number of contributors, their respective STR genotypes, and the abundance ratio of their respective contributions all may be unknown. Of course, in some circumstances the STR genotypes of one or more contributors may be known, for example where a victim or other household members contributed to the DNA sample. In such a circumstance, the STR genotypes of such known contributors may be used to enhance the accuracy of the analysis, as described further below with reference to FIG. 5.

Next, for each STR locus, data characterizing the relative abundances and sizes of STRs in the sample at that locus is obtained (step 102). Specifically, the STRs at each of the loci may be amplified using the polymerase chain reaction (PCR), using known techniques. Systems for performing PCR are commercially available, such as the STEPONE™ real-time PCR system (Life Technologies, Carlsbad, Calif.). The amplified STRs at each of the loci then may be resolved using a commercially available STR resolution system, such as a gel electrophoresis system, a capillary electrophoresis system, a DNA sequencer, a polyacrylamide gel, a DNA microarray, a mass spectrometer, or any other suitable system or combination of systems. Examples of commercially available STR resolution systems include the GENEPRINT® SILVERSTR® D7S820 System (Promega Corporation, Madison, Wis.), which is based on silver stain detection, and the POWERPLEX® 16 System (Promega Corporation, Madison, Wis.), which is configured to co-amplify and detect STR peaks at fifteen loci referred to in the art as Penta E, D18S51, D21S11, TH01, D3S1358, FGA, TPOX, D8S1179, VWA, Penta D, CSF1PO, D16S539, D7S820, D13S317 and D5S818, plus Amelogenin (AMEL) from which gender may be determined.

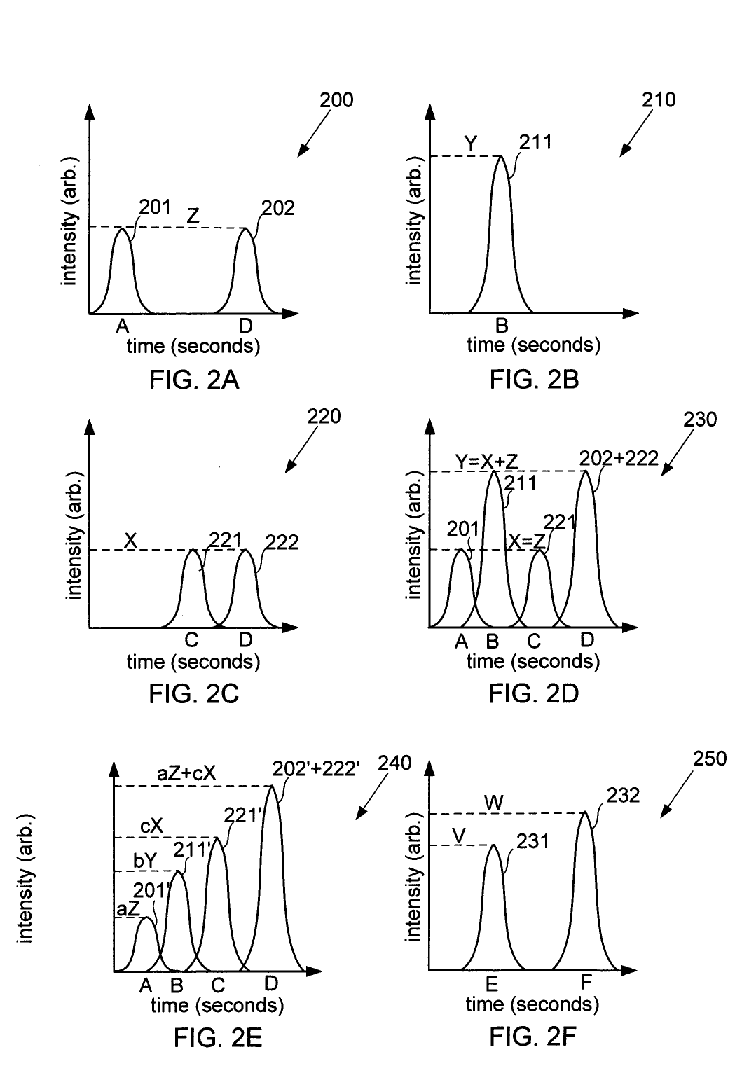

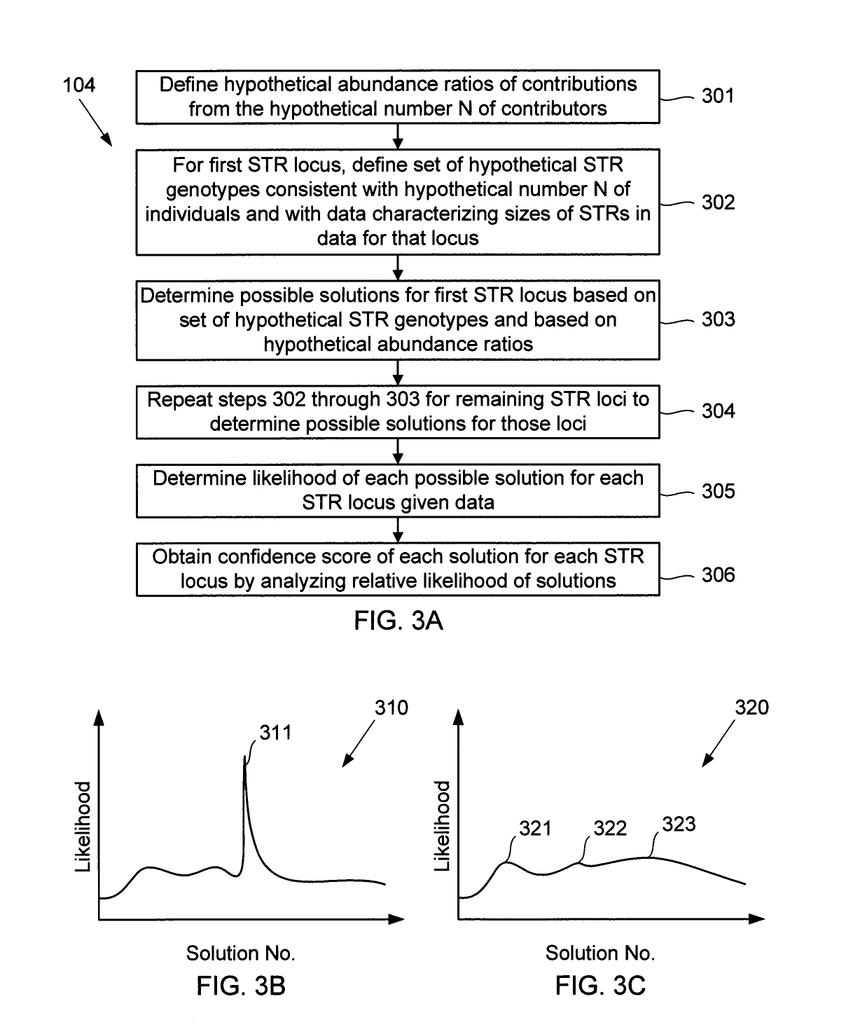

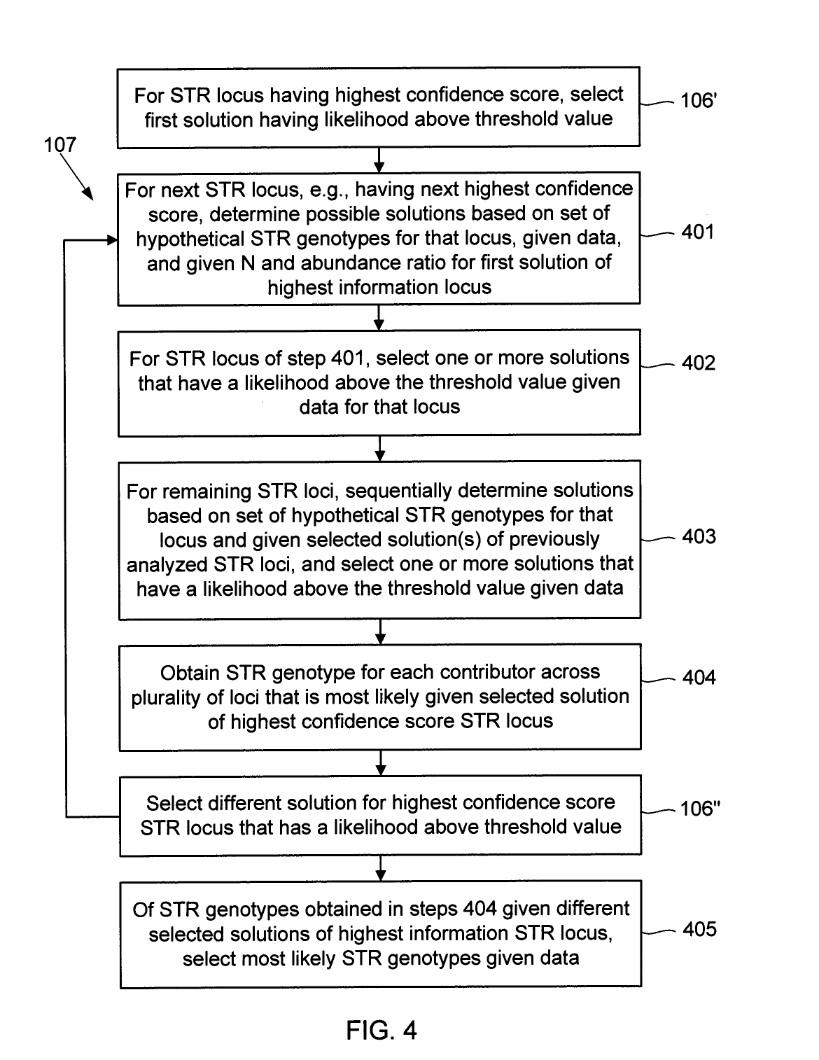

Preferably, such system yields as output for each locus an STR trace 200 such as illustrated in FIG. 2A for a first exemplary individual. In trace 200, the time axis corresponds to the relative amount of time it took the STR to pass through the STR resolution system, from which the size of the STR, and thus the number of repeats of the genetic sequence of the STR, may be inferred. In trace 200, the time axis has units of seconds, although any suitable metric related to the size of the STR or the number of repeats may be used. For example, commercially available systems may “call” the allele, e.g., provide a numeric designation of the size or the estimated number of repeats in the STR. In trace 200, the intensity axis corresponds to the relative abundance of the STR within the sample. In trace 200, the intensity axis has arbitrary units, although any suitable metric related to the abundance of the STR may be used, including area under the peak or height.

The exemplary STR trace illustrated in FIG. 2A includes first and second peaks 201 and 202, meaning that the first individual has heterozygous STR alleles at this locus, each allele having a different number of repeats. Peak 201 is at time A, while peak 202 is at time D, the different times corresponding to the different allele sizes, e.g., the different number of repeats of the genetic sequence of the two STR alleles. Peaks 201 and 202 both have the same relative intensity Z as one another because they both have the same relative abundance in the individual as one another, and the absolute value of intensity Z is related to the absolute abundance of the individual's DNA present in the sample. The relative times (and, by extension, the relative sizes) of the different peaks in an individual's STR trace for a given locus thus define the STR genotype for that individual. It will be appreciated that different individuals typically will have different STR genotypes from one another at any given locus, although there is a calculable likelihood that the STR genotypes of any two individuals may partially or fully overlap with one another at any given locus.

For example, FIGS. 2B and 2C respectively illustrate exemplary STR traces 210, 220 for second and third individuals. Trace 210 of FIG. 2B includes a single peak 211, meaning that the second individual has homozygous STR alleles at this locus, each allele having the same number of repeats as the other. Peak 211 is at time B and has intensity Y. Time B is later than time A and earlier than time D, reflecting that the second individual's STR alleles at peak 211 are larger than the first individual's allele (i.e., have more repeats) at peak 201 and smaller than the first individual's allele (i.e., have fewer repeats) at peak 202. Intensity Y reflects the relative abundance of the alleles in the second individual, as well as the absolute abundance of the second individual's DNA present in the sample. In this example, the absolute abundances of the first and second individuals' DNA in the sample are equal to one another, so peak 211 is twice as tall as peaks 201 and 202 (Y=2X) because both alleles contribute to peak 211 for the second individual, while only a single allele contributes to each of peaks 201, 202 for the first individual; that is, the relative abundance of a homozygous allele is twice as great as for a heterozygous allele.

Trace 220 of FIG. 2C includes first and second peaks 221, 222, meaning that the third individual has heterozygous STR alleles at this locus, each allele having a different number of repeats than the other. Peak 221 is at time C, while peak 222 is at time D, the different times corresponding to the different sizes, e.g., the different number of repeats of the genetic sequence, of the two STR alleles. Here, time C is later than time A and B, reflecting that the third individual's allele at peak 221 is larger (i.e., has more repeats) than the second individual's alleles at peak 211. Time D of the third individual's allele at peak 222 is the same as time D of the first individual's allele at peak 202, reflecting that these two alleles are the same as one another, i.e., that a portion of the first individual's STR genotype overlaps with a portion of the second individual's STR genotype. Peaks 221 and 222 both have the same intensity X as one another because they both have the same relative abundance in the third individual as one another, where the absolute value of intensity X is related to the absolute abundance of the third individual's DNA present in the sample. In this example, the absolute abundance of the DNA of the third individual is the same as that of the first individual (X=Z).

As may be seen from FIGS. 2A-2C, at any given locus the STR peak(s) for a given individual may occur at a variety of times and have a variety of intensities, corresponding to the possible numbers of repeats and the relative abundances of the STR alleles and the absolute abundances of that individual's DNA in the sample being analyzed. A such, when STR peaks are resolved at a selected subset of loci, they allow for essentially unique identification of an individual because it is statistically unlikely that all of the STR peak times and intensities at all of the loci—i.e., the STR genotype of the individual—will be the same as those of another individual. However, for a sample having a mixture of STR genotypes of multiple individuals, and particularly where those genotypes are mixed in an unknown ratio relative to one another, it may be difficult to readily discern which peaks in an STR trace correspond to which individual.

For example, FIG. 2D illustrates STR trace 230 for an exemplary mixed sample that includes DNA from the first, second, and third individuals of FIGS. 2A-2C in a 1:1:1 ratio of absolute abundances, and at the same locus as in FIGS. 2A-2C. Trace 230 includes first peak 201, which corresponds to peak 201 illustrated in FIG. 2A for the first individual; second peak 211, which corresponds to peak 211 illustrated in FIG. 2B for the second individual; third peak 221, which corresponds to peak 221 illustrated in FIG. 2C for the third individual; and fourth peak 202+222, which corresponds the sum of peak 202 for the first individual and peak 222 for the third individual. First peak 201 is at time A and has an intensity Z; second peak 211 is at time B and has an intensity Y (where Y=2×); third peak 221 is at time C and has an intensity X (where X=Z); and fourth peak 202+222 is at time D and has an intensity X+Z (where X+Z=Y), corresponding to the summed intensities of peaks 202 and 222 of the first and third individuals, respectively.

Given a priori knowledge about the STR genotypes of each individual contributing to a DNA sample, and the abundance ratio of those contributions in the sample being analyzed, it may be relatively easy to determine which STR peaks in trace 230 correspond to which individual. However, absent one or more portions of such a priori knowledge, it may become relatively difficult to determine which peaks correspond to which individual using previously known methods, that is, to identify the STR genotypes of each individual contributing to the genetic sample. Indeed, it may become difficult—if not computationally intractable—even to determine how many individuals contributed to a sample and in what proportions, let alone to identify the genotypes for each of the individuals, using previously known methods.

For example, FIG. 2E illustrates STR trace for a mixed DNA sample similar to that illustrated in FIG. 2D, but in which the DNA of the first, second, and third individuals of FIGS. 2A-2C are in an abundance ratio of a:b:c, where a, b, and c are not equal to one another, and in which a is small relative to b and c. Trace 240 includes first peak 201′, which corresponds to peak 201 illustrated in FIG. 2A for the first individual; second peak 211′, which corresponds to peak 211 illustrated in FIG. 2B for the second individual; third peak 221′, which corresponds to peak 221 illustrated in FIG. 2C for the third individual; and fourth peak 202′+222′, which corresponds the sum of peak 202 for the first individual and peak 222 for the third individual.

In trace 240, first peak 201′ is at time A, second peak 211′ is at time B, third peak 221′ is at time C, and fourth peak 202′+222′ is at time D reflecting that the sample contains the same STR genotypes as in trace 230 of FIG. 2D. However, the relative intensities of peaks 201′, 211′, 221′, and 202′+222′ are significantly different in trace 240 of FIG. 2E than in trace 230. For example, first peak 201′ has an intensity of aZ, corresponding to the absolute and relative abundances Z of the first individual's contribution in the sample, multiplied by the ratio a in which that contribution is present in the sample. Analogously, second peak 211′ has an intensity of bY, corresponding to the absolute and relative abundances b of the second individual's contribution in the sample, multiplied by the ratio b in which that contribution is present in the sample. Analogously, third peak 221′ has an intensity of cX, corresponding to the absolute and relative abundances X of the third individual's contribution in the sample and the ratio c in which that contribution is present in the sample. Fourth peak 102′+122′ has an intensity of aZ+cX, corresponding to the sum of the absolute and relative abundances Z, X of the first and third individuals' respective contributions in the sample and the ratios a, c in which those contributions are respectively present in the sample.

Absent a priori knowledge about the number of contributors to a DNA sample having trace 240 illustrated in FIG. 2E, the different contributors' STR genotypes at that locus, and/or the abundance ratio in which the contributions are mixed in the DNA sample, it would be very difficult—if not computationally intractable—using previously known methods to determine which peaks in trace 240 correspond which contributor, i.e., to identify each contributor's STR genotype at that locus. For example, it would be difficult to determine which of peaks 201′, 211′ 221′, and/or 202′+222′ correspond to a homozygous STR allele for a single contributor or for multiple contributors, or to a heterozygous STR allele for a single contributor or for multiple contributors, and in what relative proportion, if the STR peaks for those contributors were not a priori known. Although some computational techniques have been developed for identifying contributors' STR genotypes in DNA samples having contributions from two individuals, such techniques may not readily be extended—if at all—to identify contributors' STR genotypes in DNA samples having contributions from three or more individuals. For further details, see, for example, Perlin et al., “An Information Gap in DNA Evidence Interpretation,” PLOS ONE 4(12) e8327, pages 1-12, which is incorporated by reference herein in its entirety.

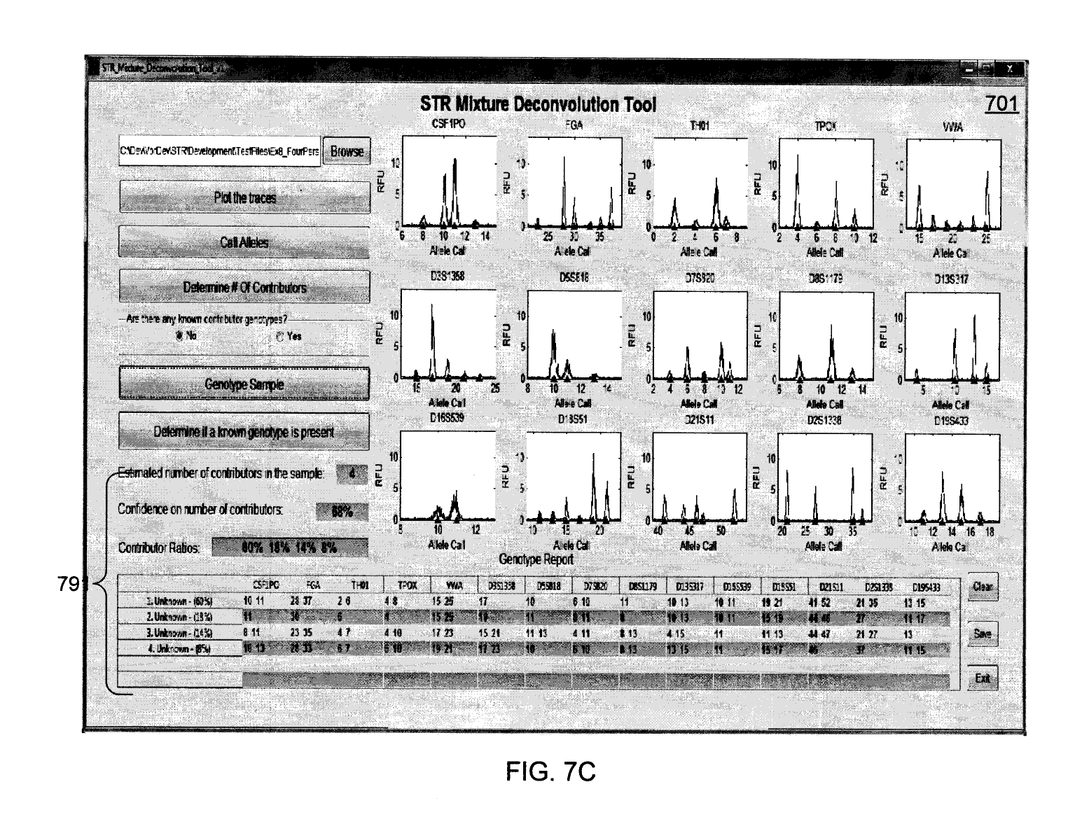

To this end, steps 103 through 109 illustrated in FIG. 1A correspond to steps of method 100 that the present inventors have developed to deconvolve from one another the STR genotypes of multiple contributors to a DNA sample, based on STR traces such as those illustrated in FIGS. 2D-2E obtained using steps 101 and 102. Method steps 103 through 109 may be performed using a suitably programmed computer. Other steps of the method, such as steps 102, 110, and 111 also may be performed using a suitably programmed computer, which may be the same computer, or a different computer, as used to perform steps 103 through 109. An exemplary suitably programmed computer for executing steps 103 through 109 (as well as any substeps or alternative embodiments thereof), and optionally one or more other computer-implemented steps, is described below with reference to FIG. 6. In some embodiments, steps 103 through 109 are implemented using any suitable programming language such as C, C#, C++, or, preferably, MATLAB (MathWorks, Natick, Mass.) that is executed by a computer.

It will be appreciated that steps 101, 102, 110, and 111 optionally may be performed separately, by other parties. For example, the data characterizing the relative abundances and sizes of STRs at each locus obtained in step 102 may be obtained by another party and stored for later use, e.g., for later execution of steps 103 through 109 using a suitably configured computer. Alternatively, steps 101 and 102 can be omitted if data characterizing the abundances and sizes of STRs at the loci of interest is already available, e.g., if the data (e.g., STR traces) has been previously obtained and stored.

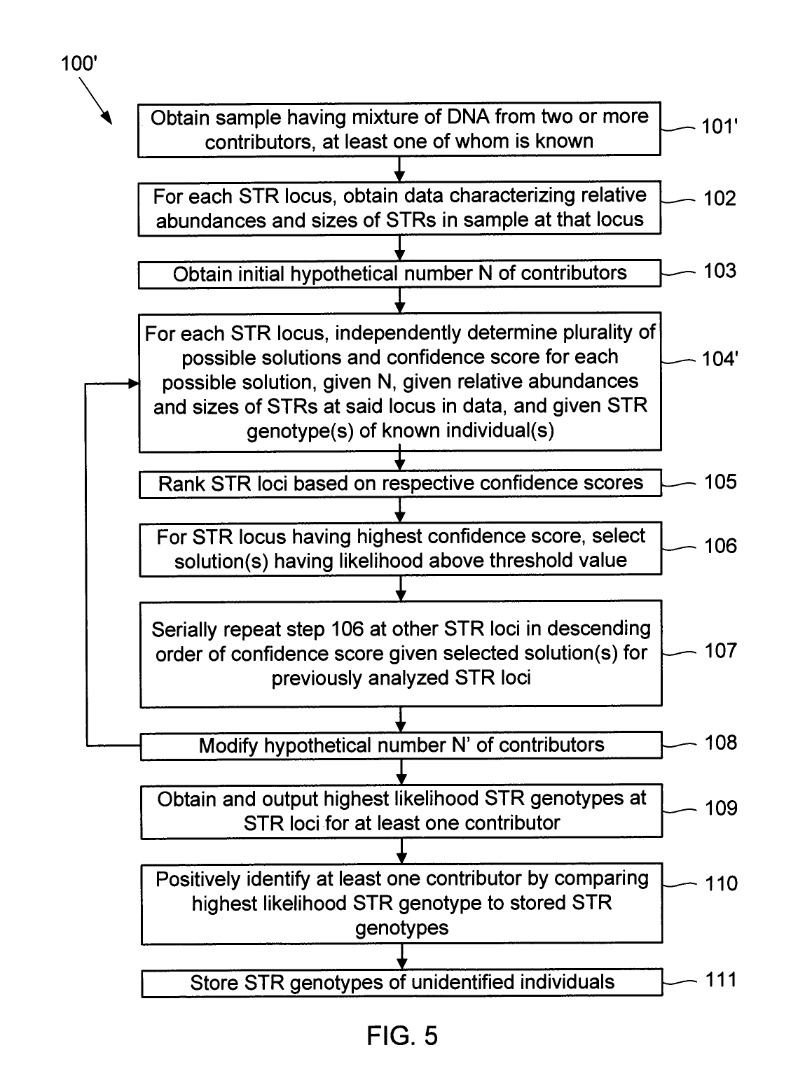

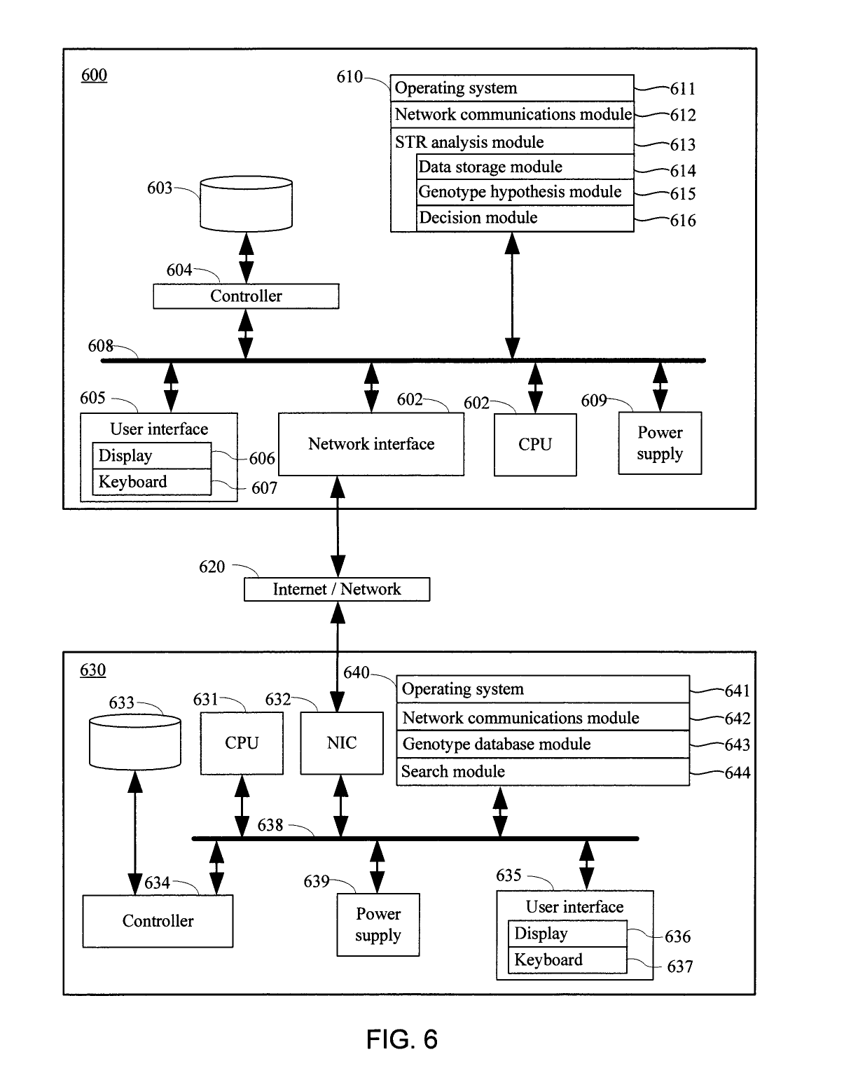

Continuing with method 100 illustrated in FIG. 1, an initial hypothesis as to the number N of contributors is obtained (step 103). As described in greater detail below with reference to FIG. 3A, such an initial hypothesis may be defined based on the number of peaks in the data for the STR locus having the greatest number of peaks, or alternatively may be defined based on population statistics of the individuals believed to have contributed to the DNA sample. N may be any suitable number, for example 2, 3, 4, 5, 6, 7, 8, 9, or 10, preferably 2, 3, 4, 5, or 6, preferably 2, 3, or 4, most preferably 3 or 4.

Then, for each STR locus, a plurality of possible solutions and the confidence score for each possible solution are obtained, given the hypothetical number N of contributors and the relative abundances and sizes of STRs at said locus in the data (step 104). Specifically, and as described in greater detail below with reference to FIGS. 3A-3C, the initial hypothetical number N of contributors are held fixed, and different solutions are independently simulated for each locus given the relative abundances and sizes of STRs in the DNA mixture at that locus. Each solution includes (a) the defined number N of contributors, (b) a defined STR genotype for each of the N contributors at that locus, and (c) a defined abundance ratio of respective contributions from the N contributors. A confidence score for each solution is then determined by comparing that solution to the data, and also by comparing the solutions to one another, so as to identify which STR locus has not only the most likely solution, but as to assess how much better that solution is than the other most likely solutions of the other loci.

Optionally, the STR loci are ranked based on their respective confidence scores (step 105). For example, the highest confidence score for each STR locus may be selected and compared to the highest confidence score for each other locus, to obtain such a ranking. The STR locus having the highest confidence score may be defined to be the “highest information locus,” i.e., as providing more information about the mixture of DNA than the other loci, because the most confidence may be placed in its most likely solutions. Note that the STR loci need not necessarily be ranked, even though their confidence scores may have been determined.

Then, for the STR locus having the highest confidence score, i.e., for the highest information STR locus, the one or more solutions having a likelihood above a threshold value are selected (step 106). The most likely solutions for the other STR loci then are serially determined, preferably in descending order of confidence score, given the abundance ratio of the selected solution(s) for any previously analyzed STR loci (step 107). That is, for the STR locus having the next highest confidence score, the locus may be analyzed by (a) determining a plurality of possible solutions for that locus given the data, given the defined number N of contributors and the defined abundance ratio of the one or more solutions for the STR locus having the highest confidence score and by (b) selecting one or more solutions for that locus that have a likelihood above the threshold value. Steps (a) and (b) may be repeated serially for each remaining STR locus, preferably in descending order of confidence score, each time using as a given the defined number N of contributors and the defined abundance ratio of the selected solutions of previously analyzed STR loci.

Note that during step 107, the STR loci may, but need not necessarily, be analyzed in descending order of confidence score. Analyzing the STR loci in descending order of confidence score may improve the rapidity with which the most likely solutions for the loci may be obtained. For example, assume that the lowest confidence score STR locus has a single peak in the data, from which it may be computationally determined that each contributor likely is homozygous and likely has the same allele as one another (otherwise, other peaks would be present in the data). However, is not possible to computationally determine from the data for this locus the abundance ratio of the respective contributions from the contributors, resulting in the relatively low confidence score for this locus. That is, each abundance ratio is computationally as likely as each other abundance ratio. As such, this STR locus provides little useful information that could be used in determining the solutions for subsequent loci, and thus would not reduce the amount of computational time needed to determine the solutions for those subsequent loci. By comparison, another, higher confidence score STR locus may have four peaks in the data, from which it may be computationally determined that only a single certain abundance ratio is likely. As such, this STR locus provides significant useful information that may be used in determining the solutions for subsequent loci, e.g., may eliminate the need to computationally determine possible solutions for those loci that are inconsistent with the abundance ratio for this locus. Thus, analyzing the loci in descending order of confidence score may expedite the computational analysis, and thus is preferred, but should not be construed as required.

The set of the most likely solutions for all of the STR loci that are consistent with the defined number N and with the defined abundance ratio of the last analyzed STR locus thus defines the most likely STR genotype of each contributor at each locus, and the abundance ratio thereof. Note, however, that such STR genotypes are not necessarily correct. For example, as described in greater detail below with reference to FIG. 3A, the initial hypothetical number N of contributors obtained in step 103 may represent the minimum number of contributors to the DNA sample. However, more contributors than that minimum number may actually have contributed to that sample. If the number N of contributors is not correct, then the defined abundance ratio may not necessarily be correct, nor may the STR genotypes of the contributors.

So as to increase the likelihood of correctly obtaining the number of contributors to the DNA sample, and thus of correctly obtaining the abundance ratio and the STR genotype of each contributor, the hypothetical number N of contributors may be modified to N′, e.g., increased by one (step 108 of method 100). Steps 104 through 107 then may be repeated to generate a new abundance ratio and STR genotypes of that number N′ of contributors. Indeed, step 108 then may be repeated again to modify the hypothetical number N′ of contributors, and steps 104 through 107 repeated again to generate a new abundance ratio and STR genotypes of that number N′ of contributors. Steps 104 through 108 may be repeated for different numbers N′ of contributors until it is determined that it is statistically likely that at least one of the joint genotype hypotheses correctly identifies the STR genotypes, and abundance ratio thereof, of all of the contributors to the DNA sample.

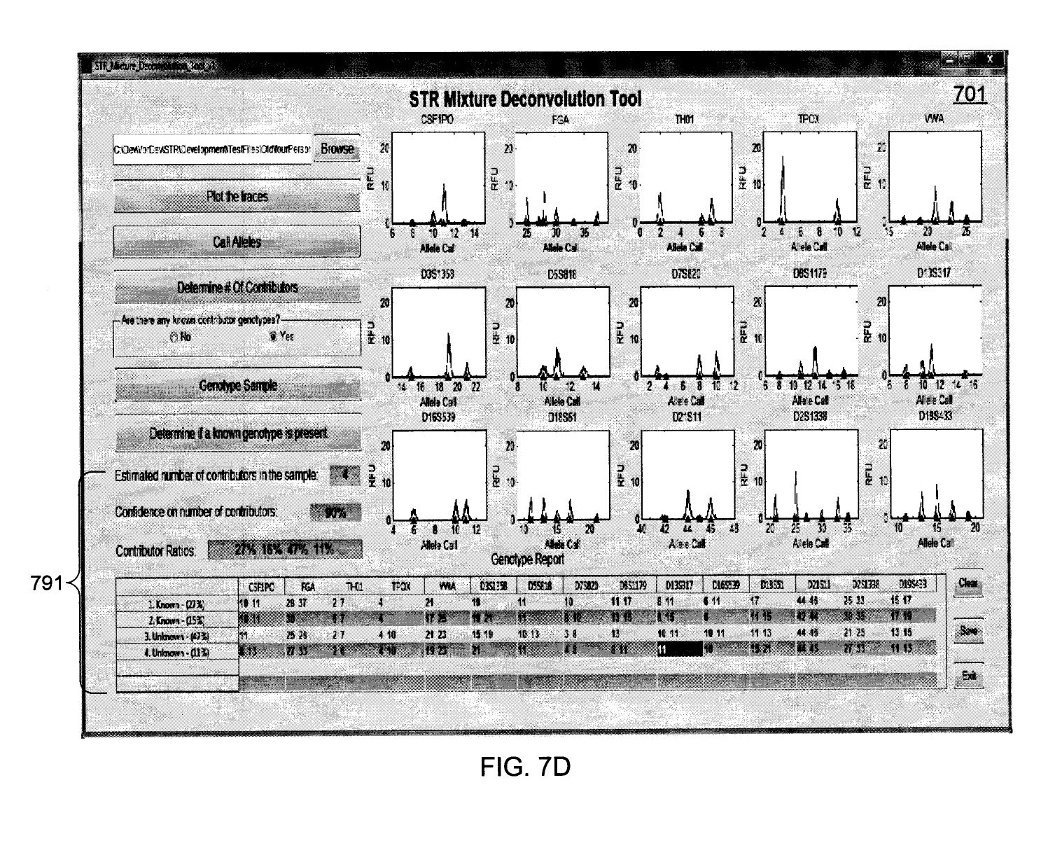

The STR genotype for the most likely selected solution for the last STR locus analyzed, and the STR genotype of each selected solution for each previously analyzed STR locus that shares as a given the same number of contributors and the same abundance ratio used to determine the most likely selected solution for the last STR locus then is outputted for at least one contributor (step 109). Optionally, such STR genotypes for some or all of the contributors are outputted. Such an output may have the exemplary format shown below in Tables 1 and 2. Table 1 includes the most likely number N of contributors, in this example four, and the statistical likelihood (confidence) that N contributors contributed to the sample, in this example 90%. Table 2 includes the most likely STR genotype of each contributor at four loci, expressed here as the size of each allele (also referred to as an “allele call”), and the respective abundance ratios of the contributors, expressed here as a percentage of the total mixture. It will be appreciated that the output not only may be provided in any suitable format (e.g., arrangement and content of information), but also may be provided in any suitable form. For example, the output may be displayed on a display device connected to the suitably programmed computer that executed steps 103 through 109, may be stored in a volatile computer-readable medium that is accessible by the computer, may be stored in a nonvolatile computer-readable medium that is accessible by the computer, may be transmitted to a remote computer, and the like. Exemplary user interfaces suitable for displaying the output are described in greater detail below with reference to FIGS. 7A-7D.

TABLE 1
Example Output

| Number of Contributors | Confidence |
|---|---|
| 4 | 90% |

TABLE 2
Example Output (Continued)

| Contributor | Contribution | Locus 1 | Locus 2 | Locus 3 | Locus 4 |
|---|---|---|---|---|---|
| 1 | 47% | 11 | 25 28 | 2 7 | 4 |
| 2 | 27% | 10 11 | 28 37 | 2 | 10 |
| 3 | 16% | 11 13 | 30 | 7 | 4 |
| 4 | 10% | 8 10 | 27 33 | 6 | 4 |

Optionally, at least one contributor to the DNA sample may be positively identified by comparing that contributor's most likely STR genotype across the loci to stored STR genotypes associated with different individuals (step 110). Indeed, many countries have developed their own national databases, which store STR genotypes for thousands or even millions of known or unknown individuals. As described in greater detail below with reference to FIG. 6, the most likely genotype of a contributor, as determined using steps 103 through 109 of method 100, may be entered into a database, e.g., one of the national databases, which then searches for an individual whose actual STR genotype across the loci is statistically likely to match the most likely STR genotype across the loci. If the database finds such a match, then the contributor may be positively identified based on that match. Such positive identification may include one or more of the matching individual's name, any crimes in which the individual is known to have participated (and the locations thereof), that individuals' social security number, last known address, and the like. In some circumstances, the individual's name may not necessarily be known although their STR genotype is stored in the database. Such an identification process may be repeated for some or all of the most likely STR genotypes of the contributors so as to positively identify some or all of those contributors.

Preferably, the loci at which steps 103 through 109 obtain the most likely solutions include some or all of the loci at which the stored STR genotypes are determined. For example, the United States national DNA database, known as Combined DNA Index System (CODIS) stores individuals' STR genotypes at thirteen STR loci known in the art as CSF1PO, D3S1358, D5S818, D7S820, D8S1179, D13S317, D16S539, D18S51, D21S11, FGA, THO1, TPOX, and vWA, plus amelogenin (AMEL) based upon which gender may be identified. Other countries' national DNA databases may store STR genotypes at other STR loci. For example, the United Kingdom National Criminal Intelligence DNA Database (NDNAD) stores STR genotypes at ten STR loci (plus AMEL), and the European Database stores STR genotypes at fifteen STR loci (plus AMEL). Steps 103 through 109 are compatible with determining the most likely solutions at any desired loci. Indeed, it should be appreciated that many embodiments of the present invention require no substantive knowledge about the loci themselves. In specific embodiments, at least 5, 6, 7, 8, 9, 10, 11, 12, 13, 14, or 15 STR loci are analyzed; optionally, AMEL is also analyzed in conjunction with this selected number of loci. In another specific embodiment, 13 loci are analyzed; optionally, AMEL is also analyzed in conjunction with this selected number of loci. In another specific embodiment, 10 loci are analyzed; optionally, AMEL is also analyzed in conjunction with this selected number of loci. In another specific embodiment, 15 loci are analyzed; optionally, AMEL is also analyzed in conjunction with this selected number of loci.

Note, however, that the STR genotypes for the most likely solutions for some or all of the contributors may not necessarily match any of the stored STR genotypes. That is, the contributor for whom the most likely STR genotype has been determined may not necessarily have been identified as being of sufficient interest to store their STR genotype in one of the national databases. In such a circumstance, method 100 optionally includes storing the most likely STR genotype of any unidentified contributor (step 111). The contributor then may be positively identified at a later time.

The individual steps of method 100 illustrated in FIG. 1, and substeps and alternative embodiments thereof, now will be described in greater detail.

Obtaining Initial Hypothesis of Number N of Contributors (Step 103)

In some embodiments, the initial hypothetical number N of contributors obtained in step 103 is based on information that reasonably may be inferred from the data obtained in step 102 of method 100 illustrated in FIG. 1. For example, the initial hypothetical number N of contributors may be obtained based on population statistics. Specifically, the known STR allele frequencies from various populations around the world are used, and the most likely abundance ratio from a given population to give rise to the observed STR profile for the highest information locus is determined. This may be accomplished using the maximum likelihood estimation (MLE) approach that is well-known in the art.

For example, it is known that the likelihood of N contributors causing the peaks in the STR trace at a given locus may be expressed as Equation 1:

$$f ( N ) = {\sum }_{{a}_{1} = 0}^{a} {\sum }_{{a}_{2} = 0}^{a - {a}_{1} - 1} … {\sum }_{{a}_{n}}^{a - {a}_{1} - … - {a}_{n} - 2} \frac{( 2 N ) ! {\prod }_{i = 1}^{n} {\prod }_{j = 0}^{{b}_{i} - 1} [ ( 1 - F ) {A}_{i} + jF ]}{{\prod }_{i = 1}^{n} {\prod }_{j = 0}^{2 N - 1} [ ( 1 - F ) + jF ]}$$

Where N is the number of contributors contributing to the mixture; n is the number of observed alleles (STR peaks) in the trace; a=2N−n is the number of unconstrained alleles; aᵢ is the number of unknown copies of the i^{th} allele out of a; bᵢ=aᵢ+1 is the unknown number of copies of the i^{th} allele, where the sum of all bᵢ between i=1 and i=n is equal to 2N; Aᵢ is the frequency of the i^{th} allele in a given population; and F is an inbreeding coefficient, which is a measure of heterozygousity of an inbred population. Specifically, in a two-allele system with inbreeding (that is, where members of a given population breed with one another and not with other populations), the genotype frequencies are known to be p²(1−F)+pF for an AA (homozygous) allele, 2pq(1−F) for AB (heterozygous) alleles, and q²(1−F) for a BB (homozygous) allele, where p and q are the allele frequencies of alleles A and B, respectively. F can be calculated as one minus the observed number of heterozygotes in a population, divided by its expected number of heterozygotes at Hardy-Weinberg equilibrium, i.e., as expressed in Equation 2:

$$F = 1 - \frac{O ( f ( AB ) )}{E ( f ( AB ) )} = 1 - \frac{Observed \# ( AB )}{n ( 2 pq )}$$

As is known in the art, the Hardy-Weinberg principle states that both allele and genotype frequencies in a population remain constant, i.e., are in equilibrium. As such, the value of F is known for a given global population.

The expected population to which the contributors are believed to belong is identified, e.g., based on the country from which the DNA sample was obtained. For example, if it is believed that all of the contributors are Caucasians, then the Caucasian population is identified. Then, the F value for that population is obtained, as are the Aᵢ frequencies for the i alleles observed in the highest information locus. F values and Aᵢ frequencies readily may be obtained from public sources, such as from the National Institute of Standards and Technology (NIST) online database, available at http:/www.cstl.nist.gov/strbase. Then, the different iterative loops described in Equation 1 are executed to obtain a hypothetical number N of contributors.

Or, for example, the number of peaks that appear in the data for the different loci may be used to infer a minimum number of contributors to the DNA sample. In the following discussion, it is assumed that data obtained in step 102 of method 100 are in the form of a two-dimensional matrix for each STR locus, the matrix for each locus having a first row corresponding to the time axis of an STR trace such as described above with reference to FIGS. 2A-2E and a second row corresponding to the intensity axis of the STR trace. However, it should be appreciated that any other suitable format may be used, including vectors, two-column matrices, matrices of greater dimension, and the like, as well as formats using allele calls rather than time. In some embodiments, the commercially available equipment used in step 102 outputs the data in the format to be used directly as input to step 103, while in other embodiments an additional step (not shown) reformats the data from step 102 into a preferred format for use in step 103.

An exemplary two-dimensional matrix describing an illustrative STR trace, for a given locus, that suitably may be used as input to step 103 is shown in Table 3. To simplify the analysis of the data in subsequent steps, the maximum intensity of each STR peak in the trace may be used to represent the overall intensity of that peak, noting that other representations of the intensity suitably may be used, such as peak volume, peak width, and the like. Additionally, the intensities of the STR peaks optionally may be normalized, e.g., against the sum of the intensities within the STR trace, as shown in Table 3, which may simplify comparison of the data to different possible solutions as described in greater detail below.

TABLE 3
Exemplary STR Trace Format

| | | | | | | | | | |
|---|---|---|---|---|---|---|---|---|---|
| Time (sec.) | 0 | 0.2 | 0.4 | . . . | 1.6 | . . . | 2.2 | 2.4 | . . . |
| Intensity (arb.) | 0 | 14 | 10 | . . . | 16 | . . . | 12 | 0 | . . . |
| Normalized | 0 | 0.27 | 0.19 | . . . | 0.31 | . . . | 0.23 | 0 | . . . |
| Intensity (arb.) | | | | | | | | | |

From the example shown in Table 3, it may be seen that the STR trace includes four peaks, the first having an intensity of 14 units at 0.2 seconds, the second having an intensity of 10 units at a time of 0.4 seconds, the third having an intensity of 16 at 1.6 seconds, and the fourth having an intensity of 12 at 2.2 seconds, from which it may be inferred that the fourth peak is the largest, and the first peak is the smallest. Because no peaks are present at other times, the intensity values are zero at those other times. Note that in a real trace, the intensity values may not necessarily be zero at times where no peaks are present because of noise. The STR peaks in the STR traces for each of the different loci may be located and counted within the trace using any suitable computational technique. For example, a peakfinding function is readily available in MATLAB which takes as input a vector or matrix and provides as output the indices of any peaks within that vector or matrix, from which the location and the number of peaks elements within the vector or matrix readily may be determined.

Or, for example, continuing with the exemplary STR trace shown in Table 3, the intensity axis may be examined using any suitable technique to identify the presence of peaks, and a peak flag such as shown in Table 4 may be set in an additional row vector at a time corresponding to that peak. The number of peak flags for the STR trace then may be summed to obtain a value P reflective of the number of peaks in the trace, in this example, P=4.

TABLE 4
Exemplary Peak Identification for STR Trace

| | | | | | | | | | |
|---|---|---|---|---|---|---|---|---|---|
| Time (sec.) | 0 | 0.2 | 0.4 | . . . | 1.6 | . . . | 2.2 | 2.4 | . . . |
| Intensity (arb.) | 0 | 14 | 10 | . . . | 16 | . . . | 12 | 0 | . . . |
| Normalized | 0 | 0.27 | 0.19 | . . . | 0.31 | . . . | 0.23 | 0 | . . . |
| Intensity (arb.) | | | | | | | | | |
| Peak Flag | 0 | 1 | 1 | . . . | 1 | . . . | 1 | 0 | . . . |

It should be understood that other suitable methods of obtaining the initial hypothetical number N of contributors alternatively may be used. For example, it may be a priori known how many individuals contributed to the DNA sample.

Regardless of the particular method used to identify and count the peaks, the number P of peaks in the STR traces for each of the loci then may be compared to one another, and based on the highest value of P the first hypothetical number N of contributors may be obtained. For example, using the example STR trace of Table 4, it may be seen that at least two people contributed to the DNA sample. One exemplary formula that may be used to obtain the minimum hypothetical number N of contributors having P peaks is N=½P, where N preferably is rounded down to a whole integer, although in some circumstances it may be desirable to round up N to a whole integer (e.g., if it is a priori known that a minimum number of individuals contributed to the sample). Note, however, that such a formula may underestimate the number of contributors. For example, although Table 4 lists four peaks, there are more than two peak heights so it is likely that more than two individuals contributed to the DNA sample. So as to compensate for possible errors in the initial hypothetical number N of contributors, this number may be varied (e.g., increased) during subsequent steps, as described in greater detail herein.

Independently Determining Possible Solutions for Each STR Locus (Step 104)

As noted above, method 100 continues by independently determining a plurality of possible solutions and a confidence score for each possible solution for each STR locus, given N and given the relative abundances and sizes of STRs at that locus in the data (step 104). FIG. 3A illustrates one embodiment of substeps that may be performed while executing step 104.

First, a range of hypothetical abundance ratios of contributions of the hypothetical number N of contributors may be defined (step 301). For example, it may be considered that any contribution greater than or equal to 5% is significant enough to identify a contributor, and that increments of 5% are sufficient to distinguish different contributors from one another. As such, an exemplary range of abundance ratios for a N-person mixture may be defined as a N-row matrix having the illustrative format shown in Table 5, for which N=2.

TABLE 5
Exemplary Range of Abundance Ratios
for Two-Contributor Mixture

| | | | | | | | | | |
|---|---|---|---|---|---|---|---|---|---|
| Cont. 1 | 0.95 | 0.9 | 0.85 | . . . | 0.5 | 0.45 | . . . | 0.1 | 0.05 |
| Cont. 2 | 0.05 | 0.1 | 0.15 | . . . | 0.5 | 0.55 | . . . | 0.9 | 0.95 |

Note that the abundance ratios for the N-contributor mixture may be expressed in any convenient format, and that the sum of their respective contributions in those abundance ratios need not necessarily equal 1 because the relative abundance of a given contribution to the DNA sample is more important than the absolute abundance. The endpoints of the range of abundance ratio, and the increments of the abundance ratio, may be selected so as to provide suitable resolution of the individuals' contributions to a DNA sample. Suitable increments may include, but are not limited to, 0.1%, 1%, 2%, 5%, 10%, and the like, and the endpoints may include any suitable value between 0.001% and 99.999%, such as 0.01% and 99.99%, or 0.1% and 99.9%, or 1% and 99%, and so on.

Then, for a first STR locus, a set of hypothetical STR genotypes is defined that is consistent with the hypothetical number N of contributors defined in step 103 and the abundances and sizes of the STR peaks in the data obtained in step 102 (step 302). For example, each of the N contributors may have homozygous or heterozygous STR alleles at this locus. As such, the set of hypothetical STR genotypes may reflect, as appropriate, the possibilities that all contributors are homozygous; that one contributor is homozygous and the rest are heterozygous; that two contributors are homozygous and the rest are heterozygous; and so forth. Additionally, because the abundances and sizes of the STR peaks are known from the data, but it is not known based on the data which peak may belong to which contributor, the set of hypothetical STR genotypes may reflect, as appropriate, the possibilities that one of the peaks belongs to one homozygous contributor and other peaks belong to other contributor; that two of the peaks belong to one heterozygous contributor and the other peaks belong to other contributors, and so forth. Thus, the set for the first locus includes a different hypothetical STR genotype corresponding to each possible combination of STR alleles that is consistent with the hypothetical number N of contributors and the peak sizes and abundances in the data for that locus.

For example, Table 6 provides an exemplary set of hypothetical STR genotypes at the first locus for the P=4 STR peaks and N=2 contributors described in Tables 3-5 above. The set readily may be extended for a greater number of contributors or for a locus with different peaks. Note that for the STR trace for this particular locus, hypothetical STR genotypes in which either of the hypothetical N=2 contributors are homozygous are incompatible with the number P=4 of peaks, because the contributors then would share less than four alleles between them. Thus, it is not necessary to include such inconsistent genotypes in the set. Any suitable algorithm may be used to define the possible STR genotypes that should be included in the set using a simple set of rules, such as “if N≦P−4, then hypothesize at most two homozygous contributors and the rest heterozygous,” “if N≦P−3, then hypothesize at most one homozygous contributor and the rest heterozygous,” and “if N≦P−2, then hypothesize only heterozygous contributors.” Based on the permissible number of homozygous or heterozygous contributor, the alleles of each contributor may be assigned in each hypothetical STR genotype to the locations of the STR peaks in the first STR locus, in this example, the peaks at 0.2 seconds, 0.4 seconds, 1.6 seconds, and 2.2 seconds for the STR trace described above in Table 3 (which alternatively may be expressed as allele calls).

TABLE 6
Exemplary Set of Hypothetical STR Genotypes at First Locus

| | | |
|---|---|---|
| Hypothesis | Contributor 1 - | Contributor 2 - |
| No. | STR Genotype | STR Genotype |

| | | | | |
|---|---|---|---|---|
| 1 | 0.2 | 0.4 | 1.6 | 2.2 |
| 2 | 0.2 | 1.6 | 0.4 | 2.2 |
| 3 | 0.2 | 2.2 | 1.6 | 0.4 |
| . . . | . . . | . . . | . . . | . . . |
| ½(N × P) | 2.2 | 1.6 | 0.4 | 0.2 |

In general, the total number of possible combinations of hypothetical STR genotypes of N contributors for P peaks is N×P. However, because some of those combinations are redundant with one another (e.g., genotype 0.2, 0.4 for a first contributor is redundant with genotype 0.4, 0.2 for that same contributor), then any such redundant combinations may be eliminated, thus reducing the total number of hypothetical STR genotypes to ½(N×P).

Then, a plurality of possible solutions for the first STR locus are determined based on the set of hypothetical STR genotypes defined in step 302 and the hypothetical abundance ratios defined in step 301 (step 303). For example, Table 7 describes several illustrative solutions that were determined by applying the hypothetical abundance ratios defined in Table 5 to the hypothetical STR genotypes defined in Table 6, e.g., in which each of the contributors' possible hypothetical genotypes is simulated as being present in the DNA sample in all possible abundance ratios. As such, the intensity of each STR peak in a solution corresponds to the abundance ratio for the contributor to which that peak corresponds, and the location of that peak in the solution corresponds to the STR allele for that contributor.

TABLE 7
Exemplary Possible Solutions at First Locus

| Solution | Contributor 1 | | | | Contributor 2 | | | |
|---|---|---|---|---|---|---|---|---|
| No. | Loc. | Int. | Loc. | Int. | Loc. | Int. | Loc. | Int. |
| 1 | 0.2 | 0.95 | 0.4 | 0.95 | 1.6 | 0.05 | 2.2 | 0.05 |
| 2 | 0.2 | 0.9 | 0.4 | 0.9 | 1.6 | 0.1 | 2.2 | 0.1 |
| . . . | . . . | . . . | . . . | . . . | . . . | . . . | . . . | . . . |
| 32 | 0.2 | 0.05 | 0.4 | 0.05 | 1.6 | 0.95 | 2.2 | 0.95 |
| 33 | 0.2 | 0.95 | 1.6 | 0.95 | 0.4 | 0.05 | 2.2 | 0.05 |
| . . . | . . . | . . . | . . . | . . . | . . . | . . . | . . . | . . . |
| ½(N × P) × R | 2.2 | 0.05 | 1.6 | 0.05 | 0.4 | 0.95 | 0.2 | 0.95 |

Note that although steps 301, 302, and 303 are described as being sequentially performed for simplicity of explanation (e.g., to more easily explain the separate concepts of hypothetical abundance ratios, hypothetical STR genotypes, and application of those ratios to those genotypes to determine possible solutions), these three steps need not necessarily be executed as separate steps from one another. Instead the different hypothetical abundance ratios and hypothetical STR genotypes may be simulated concurrently with one another in a single step. Additionally, note that because the different solutions, having various hypothetical STR genotypes and mixtures thereof, are being simulated for a single locus, and for a specific number N of contributors, the calculations involved in steps 301 through 303 therefore take a relatively small amount of computing time that scales linearly with the hypothetical number N of contributors, the number R of hypothetical abundance ratios, and the number of peaks in the data, e.g., in the STR trace.

Steps 302 through 303 then are repeated for the remaining STR loci to determine possible solutions for those loci given the data (step 304). Note that the data for each STR locus defines the possible STR genotypes of contributors for the solutions at that locus, that is, the sizes of the alleles in the data at that locus define the sizes of the alleles to be simulated in a given solution. Therefore, no information about the locus, beyond that which readily may be obtained from the data, is needed to obtain the possible solutions.

Then, the likelihood of each possible solution for each STR locus is determined (step 305). The comparison between the different simulated sets of STR peaks and the data, and the selection of the set most likely to match the data, may be performed using any suitable method, such as maximum likelihood estimation (MLE), subtraction, or root mean squared (RMS) error.

In one example, each solution, e.g., each simulated set of STR peaks, is subtracted from the STR trace, from which the difference Δ_{P} between each simulated peak and the corresponding peak in the trace is obtained. The sum Δ_{Total} of the absolute values of these differences then is obtained, and the value of this sum may be used as a metric of similarity between the simulated set of peaks and the trace. Note that in such a subtraction-based comparison, preferably the simulated set of STR peaks and the STR trace are both normalized in a similar manner to one another, e.g., both normalized against the sum of the intensities of all the peaks, so as to facilitate comparison of the simulated and actual peak intensities to one another. For example, as shown in Table 8, the intensities of the simulated STR peaks in the different solutions (I.S.) for the first locus are normalized against the sum of the intensities of all of the peaks by virtue of the way the abundance ratios were defined in Table 5, and the intensities of the STR trace peaks (I.T.) are normalized as described above with reference to Table 3.

TABLE 8
Exemplary Comparison of Solutions to STR
Trace at First Locus Based on Subtraction

| | | I.S. | | I.S. | | I.S. | | I.S. | |
|---|---|---|---|---|---|---|---|---|---|
| Solution | | I.T. | | I.T. | | I.T. | | I.T. | |
| No. | Loc. | Δ_{P} | Loc. | Δ_{P} | Loc. | Δ_{P} | Loc. | Δ_{P} | Δ_{Total} |
| 1 | 0.2 | 0.95 | 0.4 | 0.95 | 1.6 | 0.05 | 2.2 | 0.05 | 1.88 |
| | | 0.27 | | 0.19 | | 0.31 | | 0.23 | |
| | | 0.68 | | 0.76 | | −0.26 | | −0.18 | |
| 2 | 0.2 | 0.9 | 0.4 | 0.9 | 1.6 | 0.1 | 2.2 | 0.1 | 1.68 |
| | | 0.27 | | 0.19 | | 0.31 | | 0.23 | |
| | | 0.63 | | 0.71 | | −0.21 | | −0.13 | |
| . . . | . . . | . . . | . . . | . . . | . . . | . . . | . . . | . . . | . . . |
| 33 | 0.2 | 0.9 | 1.6 | 0.9 | 0.4 | 0.1 | 2.2 | 0.1 | 1.44 |
| | | 0.27 | | 0.31 | | 0.19 | | 0.23 | |
| | | 0.63 | | 0.59 | | −0.09 | | −0.13 | |
| . . . | . . . | . . . | . . . | . . . | . . . | . . . | . . . | . . . | . . . |
| ½(N × P) × R | 2.2 | 0.05 | 1.6 | 0.05 | 0.4 | 0.95 | 0.2 | 0.95 | 1.88 |
| | | 0.23 | | 0.31 | | 0.19 | | 0.27 | |
| | | −0.18 | | −0.26 | | 0.76 | | 0.68 | |

From Table 8, it may be seen that the STR peaks of solution 33 has the lowest Δ_{Total} of the simulations shown in the table, and that therefore solution 33 is the most likely solution. Note, however, that because the different solutions capture a wide range of possible combinations of hypothetical STR genotypes and abundance ratios, the single most likely solution (i.e., the one having the lowest Δ_{Total}) is likely not among those shown in Table 8. However, for purposes of the present discussion, please assume for the present purposes that solution 33 does represent the most likely match to the STR peaks. Note also that because such comparison for a specific number of hypothetical STR genotypes, the comparison takes a relatively small amount of computing time that scales linearly with the number of loci and with the number of simulations performed, that is, with the hypothetical number N of contributors, the number P of peaks at each locus, and the range R of hypothetical abundance ratios.

Preferably, a confidence score then is obtained for each solution for each STR locus by analyzing the relative likelihood of the solutions (step 306). In some embodiments, the confidence score is a “likelihood ratio” or LR, between the likelihood metric (e.g., Δ_{Total} in the present example) of the selected STR simulation and the likelihood metric of the second best STR simulation. For example, assuming that solution 33 described above with reference to Table 8 is the solution that most closely matches the STR peaks, and that solution 2 is the next most likely solution, the LR for solution 33 is 1.44/1.68, or 0.85. It will be appreciated that depending upon the particular metric used to determine the likelihoods of the various solutions, the values of the LRs may vary and their meaning suitably may be interpreted. Preferably, the values of the LRs may be compared to one another to identify the LR corresponding to the highest confidence score. Alternatively, the values of the LRs may be compared to a predetermined threshold.

In other embodiments, the confidence scores for the solutions alternatively, or additionally, is determined based on an analysis of the distribution of the likelihoods of the solutions. Specifically, the distribution of the likelihoods may vary based on the relative how closely each solution matches the data. For example, if for one particular locus one particular solution at that locus matches is significantly closer to the data than the other solutions at that locus, then the distribution of likelihoods for that locus will contain a “peak” corresponding to that particular solution. On the other hand, if all of the solutions for a given STR locus are approximately as likely as one another, such as in the above-mentioned case where the STR trace contains a single peak thus making each abundance ratio equally likely, then the distribution of likelihoods for that locus will be relatively “flat.” FIG. 3B illustrates an exemplary “peaky” distribution 310 of likelihoods (y-axis) for various solutions (x-axis) for a given locus, in which it may be seen that peak 311 corresponds to a single particularly likely solution, while FIG. 3C illustrates an exemplary “flat” distribution 321 of likelihoods for a different locus, in which it may be seen that peaks 321, 323, and 323 have similar likelihoods to one another and to the other solutions, so less confidence may be placed in such solutions.

Any suitable metric of the “peakiness” or “flatness” of the distribution of likelihoods for the various solutions may be used as a confidence score for those solutions. For example, the sparsity of the distribution—a measure of “peakiness” of a distribution—may be analyzed using techniques known in the art. Briefly, for a vector X having the likelihoods as its elements xᵢ, the sparsity of the vector may be determined by obtaining its 1^{p}-norm, where 0≦p≦1, by raising each of the elements xᵢ to the p^{th} power, obtaining the sum of those values, and taking the p^{th} root of the sum. The value of p suitably may be selected to stably recognize peaks in the particular distribution being analyzed. Alternatively, the kurtosis of the distribution—also a measure of “peakiness” of a distribution—may be analyzed using techniques known in the art. Briefly, for a vector X having the likelihoods as its elements xᵢ, the kurtosis of the vector may be defined using the following Equation 3:

$$Kurtosis = \frac{{μ}_{4}}{{σ}^{2}} - 3 = \frac{\frac{1}{n} {\sum }_{i = 1}^{n} {( {x}_{i} - \overline{x} )}^{4}}{{( \frac{1}{n} {\sum }_{i = 1}^{n} {( {x}_{i} - \overline{x} )}^{2} )}^{2}} - 3.$$

In Equation 3, μ₄ is the fourth moment of the vector X around the mean X̅ of the elements xᵢ, σ is the variance, i.e., the second moment of the vector X around the mean X̅, and n is the number of elements in the vector.

Note that the STR locus having the highest confidence score may be considered to be the highest information locus of those being analyzed. By “highest information locus,” it is meant the STR locus from which the greatest amount of information about the number of contributors may be obtained. In some circumstances, this locus may have the greatest number P of peaks relative to other loci being analyzed. For example, referring back to FIG. 2E, it may be seen that for trace 240, which corresponds to a given locus, P=4. Without knowing more about who contributed to the sample, it may readily be ascertained that at least two individuals contributed to the sample, and possibly more. For example, if two individuals contributed to the sample, both were heterozygous, and both had different alleles than one another, then the resulting trace would have four peaks, with one pair of peaks having the same intensity as each other and another pair of peaks having the same intensity as each other. However, in trace 240, each of the peaks has different intensities than each of the other peaks, meaning that at least three individuals likely contributed to the sample (otherwise there would only be two different peak heights, one for each individual). By comparison, FIG. 2F illustrates trace 250, which corresponds to a different given locus than in FIG. 2E, includes peak 231 at time E and intensity V, and peak 232 at time F and intensity W (P=2). The locus corresponding to trace 250 contains less information about the number of contributors than does the locus corresponding to trace 240, because it contains fewer peaks than does trace 240. For example, although the intensities of peaks 231 and 232 are different from one another, it is difficult to uniquely determine whether trace 240 corresponds to two homozygous contributors, each having a different allele than one another, or to some greater number of contributors having the same alleles as one another. As such, the locus corresponding to trace 240 provides more information about the number of contributors than does the locus corresponding to trace 250, and is considered to be the “highest information locus” of the two.

Note, however, that the highest information locus may not necessarily be the STR locus having the most peaks. For example, a given locus may have numerous peaks, but if a sufficient number of the peaks are the same heights as one another, then many different abundance ratios may be equally likely as one another.

Ranking Loci (Step 105 of Method 100)

Regardless of the metric used in step 104 for the confidence scores of the solutions for the different loci, the STR loci optionally may be ranked based on their confidence score (step 105 of method 100 illustrated in FIG. 1). For example, the highest confidence score for each locus may be selected, and then the loci ranked according to those selected scores.

Obtaining STR Genotypes for N Contributors (Steps 106-108 of Method 100)

As noted above with reference to method 100 of FIG. 1, the analysis of the different loci may be simplified by using the most likely solutions for the STR locus with the highest confidence score in a “greedy” manner. In particular, the abundance ratios and number of contributors of the most likely solutions of the highest confidence locus are used as a given when obtaining the solutions of the other loci.

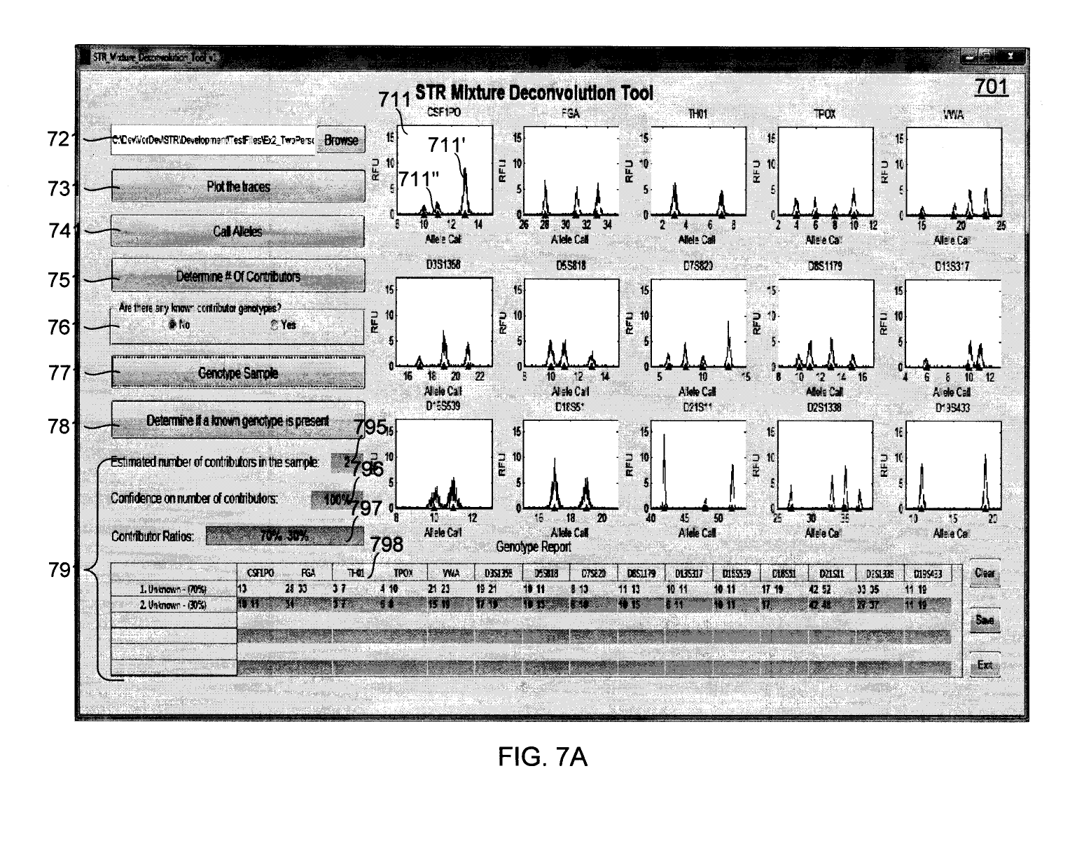

As illustrated in FIG. 4, for the STR locus having the highest confidence score as determined using step 104 and optional step 105, a first solution is selected that has a likelihood above a threshold value (step 106′). The threshold value may be suitably selected to reduce the number of solutions to be analyzed to a computationally feasible number, while allowing for the possibility that the single most likely solution is not necessarily the correct one.

As illustrated in FIG. 1, the most likely solutions for the other STR loci are then serially determined, preferably in descending order of confidence score, given the abundance ratio of the selected solution(s) for previously analyzed STR loci (step 107). FIG. 4 illustrates exemplary substeps of step 107 that may be used to obtain such solutions for the other loci. Specifically, the possible solutions for the next STR locus, which in some circumstances may be the STR locus having the next highest confidence score, are determined given the data for that locus and given the hypothetical number N of contributors and the abundance ratio for the first solution of the highest information locus (step 401). Such solutions may be similar to those obtained in step 304. Note, however, that the first solution selected in step 106′ for the highest confidence score locus defines a specific abundance ratio. As such, the possible solutions obtained for the next highest confidence score locus need not include variations of the abundance ratio. Note, however, that in some embodiments the possible solutions determined in step 401 optionally may include variations of the abundance ratio.

In an exemplary embodiment, the solutions for the STR locus of step 401 are illustrated in Table 9, in which it is assumed that the STR trace for this locus has four peaks at 0.3 seconds, 0.8 seconds, 0.9 seconds, and 1.2 seconds, each having a given intensity. The computational time to simulate the sets of STR peaks for this locus scales linearly with the number N of contributors and the number P of peaks.

TABLE 9
Exemplary Sets of Simulated STR Peaks at Locus of Step 401

| Solution | Contributor 1 | | | | Contributor 2 | | | |
|---|---|---|---|---|---|---|---|---|
| No. | Loc. | Int. | Loc. | Int. | Loc. | Int. | Loc. | Int. |
| 1 | 0.3 | 0.9 | 0.8 | 0.9 | 0.9 | 0.1 | 1.2 | 0.1 |
| 2 | 0.3 | 0.9 | 0.9 | 0.9 | 0.8 | 0.1 | 1.2 | 0.1 |
| . . . | . . . | . . . | . . . | . . . | . . . | . . . | . . . | . . . |
| 15 | .08 | 0.9 | .09 | 0.9 | 0.3 | 0.1 | 1.2 | 0.1 |
| . . . | . . . | . . . | . . . | . . . | . . . | . . . | . . . | . . . |
| ½(N × P) | 1.2 | 0.9 | 1.6 | 0.9 | 0.8 | 0.1 | 0.3 | 0.1 |

Then, for the STR locus of step 401, one or more solutions are selected that have a likelihood above the threshold value given the data for that locus (step 402). The solutions may be selected analogously as described above, e.g., by comparing each solution to the data, using a suitable metric to express the difference between the solution and the data, and comparing that metric to a suitable threshold value.

Then, for each remaining STR locus, the possible solutions are sequentially determined based on the set of STR genotypes for those loci (e.g., as determined in step 304), given the selected solution(s) of any previously analyzed loci, and the most likely of such solutions are selected (step 403). Such analysis may be analogous to that described above with reference to step 402.

The result of steps 401 through 403 is the most likely STR genotype for each contributor across the plurality of STR loci given the solution of the highest confidence score STR locus that was selected in step 106′ (step 404, which need not necessarily be executed as a separate step from steps 401 through 403). The computational time for obtaining such STR genotypes scales linearly with the number of hypothetical STR genotypes and the number of loci.

Then, if another solution for the highest confidence score STR locus has a likelihood above the threshold value, that solution is selected and steps 401 through 404 are repeated (106″). Step 106″ and steps 401 through 404 may be repeated a suitable number of times until all of the most likely solutions at the highest confidence score STR locus have been used as givens, based upon which different STR genotypes are determined using steps 401 through 404. Then, of the different STR genotypes obtained in step 404 given the different selected solutions of the highest information STR locus, the most likely STR genotypes are selected given the data (step 405). Each set of STR genotypes shares as a given the same defined number N of contributors and the same defined abundance ratio as one of the selected solutions of the highest information STR locus. Which STR genotype is the most likely may be selected by comparing the solutions corresponding to that genotype to the data at each locus, in the manner described above.

Depending on the actual number of contributors to the DNA sample and their respective contributions, the hypothetical number N of contributors upon which the above-described STR genotypes selected in step 405 is based may be sufficiently accurate that the selected STR genotypes sufficiently match the corresponding actual contributors' STR genotypes to allow a positive identification of at least one contributor to the DNA sample. However, the hypothetical number N of contributors instead may be insufficiently accurate that the STR genotypes selected in step 405 insufficiently match the corresponding actual contributors' STR genotypes to allow a positive identification of any of the contributors. As such, as illustrated in FIG. 1, the hypothetical number N′ of contributors may be modified (step 108) and steps 104 through 107 (and substeps thereof) may be repeated. For example, the number N may be incremented upwards (or downwards) by one. The hypothetical number N′ of contributors suitably may be modified, and STR genotypes determined based on same, any suitable number of times.

Outputting STR Genotypes for Most Likely Solution (Step 109)

Referring again to FIG. 1, the STR genotypes for the most likely solution for the last analyzed STR locus, as well as the STR genotypes of the most likely solution that shares as a given the same number N (or N′) of contributors and the same abundance ratio as the last analyzed STR locus is output for at least one contributor (step 109). The outputted STR genotypes are those which is most likely to match the data, e.g., the STR traces, across all of the loci. The outputted STR genotypes may be selected in a manner analogous to that described above with reference to step 305 described above, e.g., by comparing the STR peaks for each solution at each locus to the corresponding STR trace for that locus, and identifying the solution that most closely matches the traces across all of the loci. The likelihood ratio (LR) may be used to characterize the relative confidence in the selected joint genotype hypothesis, or alternatively sparsity using an 1^{p}-norm or kurtosis, as described in greater detail above. The likelihood and/or the confidence score may be above (or below) a predefined threshold, which may vary depending on the particular comparison method being used. Note that each solution may be compared to the data and the relative confidence in that solution may be characterized as each solution separately is generated, rather than first generating a plurality of solutions and then comparing each to the data. As such, if a solution that sufficiently closely matches the data is generated early on, then additional solutions need not necessarily be generated, thus saving computational time.

In some embodiments, the outputted solution is displayed in the format described above with reference to Tables 1 and 2, e.g., including “allele calls” for the STRs in each of the contributors' STR genotypes. Software algorithms for generating an allele call based on an STR peak's time in an STR trace are well known in the art. Commercial examples of software configured to generate allele calls for STR peaks include TRUEALLELE® (Cybergenetics, Pittsburgh, Pa.), FSS-i³™ (Promega Corporation, Madison, Wis.), and GENESCAN™/GENEMAPPER™ (Life Technologies Corporation, Carlsbad, Calif.).

The outputted solution thus includes the hypothetical number N or N′ of contributors most likely to have contributed to the DNA sample, the most likely STR genotypes of each of those contributors, and the most likely abundance ratio of those genotypes. As such, the selected outputted solution facilitates positively identifying at least one contributor who contributed to the DNA sample, if so desired (step 110 illustrated in FIG. 1), and/or storing the most likely STR genotypes of one or more unidentified contributors (step 111 illustrated in FIG. 1).

Note that more than one solution optionally may be outputted. For example, in some circumstances, two or more solutions have relatively similar likelihoods to one another. In such circumstances, it may be desirable to output each such solution.

Additionally, it should be noted that the systems and methods of the present invention need not necessarily include any active measures for eliminating potential artifacts that, as known in the art, may appear in an STR trace. Examples of such artifacts may include, for example, “PCR stutter” which may cause an additional, smaller peak to appear near the actual STR peak for a given allele, “allelic drop-in” which may cause appearance of extraneous alleles in an STR trace, “allelic drop-out” which may cause an allele not to appear in an STR trace, and “peak imbalance” which may cause heterozygous alleles of a given individual to have different intensities than one another in an STR trace. The systems and methods of the present invention are relatively robust against such artifacts because although such artifacts may occur for some of the STR peaks in some of the traces, the joint genotype hypothesis contains the most likely combination of STR genotypes across all of the loci, thus diminishing the relative importance of the artifacts. Alternatively, the solutions may be modified to include simulated artifacts associated with one or more of the STR peaks and thus account for such artifacts when obtaining the joint genotype hypothesis.

Modification of Method 100 to Include a Priori Known Information

As will be appreciated, in some circumstances information may be a priori known about one or more contributor to the DNA sample. For example, a DNA sample obtained from a particular piece of evidence may include contributions not only from an unidentified contributor, whose STR genotype is not known, but also from a victim, whose STR genotype readily may be obtained based on a DNA sample from that contributor alone. As illustrated in FIG. 5, modified method 100′ may be used to include such a priori known information during the generation of the joint genotype hypothesis, which may increase the accuracy of the selected joint genotype hypothesis and the amount of computational time used to obtain that hypothesis. Method 100′ includes step 101′ that is modified relative to step 101 of method 100 in that the DNA sample include a mixture of DNA for two or more contributors, in which at least one contributor has a known STR genotype. Steps 102 and 103 of modified method 100′ proceed analogously to steps 102 and 103 described above for method 100.

Method 100′ also includes step 104′ that is modified relative to step 104′ of method 100. Specifically, during step 104′, the hypothetical number N of contributors, the abundance ratio, and the STR genotypes of any known contributors are fixed. For example, rather than including in the possible solutions different STR genotypes for that known contributor, such as illustrated in Table 6, that contributor's STR genotype instead may be fixed and the STR genotypes of the other, unknown contributors may be varied in the possible solutions. The STR most likely STR genotypes of the other contributors then may be obtained and outputted in a manner analogous to that described above with reference to steps 104 through 109 of FIG. 1.

Computer-Based Systems for Implementing Method 100

Now that an overview of the methods of the present invention, e.g., for obtaining a joint genotype hypothesis that is most likely to match the data, a description of one exemplary suitably programmed computer configured to implement such methods now will be described with reference to FIG. 6.

The computer-based architecture illustrated in FIG. 6 includes STR hypothesis system 600 that is configured to implement method 100, and STR database 630 that is configured to store searchable STR genotypes of known contributors, e.g., a national database such as CODIS that may be configured to communicate with STR hypothesis system 600 via the Internet or other network 620, or alternatively may be co-located with system 600. It will be appreciated that STR database 630 may be operated by an independent entity and need not necessarily be considered to be part of the present invention.

As illustrated in FIG. 6, STR hypothesis system 600 includes one or more processing units (CPU's) 601, a network or other communications interface (NIC) 602, one or more magnetic disk storage and/or persistent devices 603 optionally accessed by one or more controllers 604, a user interface 605 including a display 606 and a keyboard 607 or other suitable device for accepting user input, a memory 610, one or more communication busses 608 for interconnecting the aforementioned components, and a power supply 609 for powering the aforementioned components. Data in memory 610 can be seamlessly shared with non-volatile memory 603 using known computing techniques such as caching. Memory 610 and/or memory 603 can include mass storage that is remotely located with respect to the central processing unit(s) 601. In other words, some data stored in memory 610 and/or memory 603 may in fact be hosted on computers that are external to STR hypothesis system 600 but that can be electronically accessed by system 600 over an Internet, intranet, or other form of network or electronic cable using network interface 602.

Memory 610 preferably stores an operating system 611 that is configured to handle various basic system services and to perform hardware dependent tasks, and a network communications module 612 that is configured to connect STR hypothesis system 600 to various other computers such as STR database 630 and possibly to other computers via one or more communication networks, such as the Internet, other wide area networks, local area networks (e.g., a local wired or wireless network can connect the STR hypothesis system 600 to the STR database 630), metropolitan area networks, and so on.

Memory 610 preferably also stores an STR analysis module 613 that includes a plurality of modules configured to execute the various steps of method 100. For example, STR analysis module 613 includes a data storage module 614 configured to store STR data, e.g., STR traces obtained for a DNA sample such as described above with reference to steps 101 and 102 of FIG. 1. STR analysis module 613 also includes a genotype hypothesis module 615 configured to define the various hypothetical numbers of contributors, their respective hypothetical STR genotypes at each of the loci, and the hypothetical abundance ratios, to simulate the STR peaks at each of the loci based on same, and to obtain solutions based on the same (steps 103-109 of FIGS. 1, 3, and 4). Genotype hypothesis module 615 may include, or may work in conjunction with, a decision module 616 that is configured to compare the solutions to the data stored by module 614, to select the combinations of STR genotypes that most closely match the data at each of the loci to obtain the solution to be outputted (step 109 of FIGS. 1 and 4). As appropriate, decision module is also configured to cause display 606 to display the selected solution, to store the selected solution in memory 603 and/or memory 610, and/or to transmit the STR genotypes of the selected solution to STR database 630 for use in positively identifying at least one contributor (step 110 of FIG. 1) or for storage (step 111 of FIG. 1).

Typically, STR database 630 may include one or more processing units (CPUs) 631; a network or other communications interface (NIC) 632; one or more magnetic disk storage and/or persistent storage devices 633 that store a searchable database of STR genotypes of known contributors and that are accessed by one or more controllers 634; a user interface 635 including a display 636 and a keyboard 637 or other suitable device configured to accept user input; a memory 640; one or more communication busses 638 for interconnecting the aforementioned components; and a power supply 639 for powering the aforementioned components. In some embodiments, data in memory 640 can be seamlessly shared with non-volatile memory 633 using known computing techniques such as caching.

The memory 640 preferably stores an operating system 641 configured to handle various basic system services and to perform hardware dependent tasks; and a network communication module 632 that is configured to connect STR database 630 to other computers such as STR hypothesis system 600. The memory 640 preferably also stores genotype database module 643 that is configured to access STR genotypes stored in magnetic disk storage and/or persistent storage devices 633. The memory 640 preferably also includes search module 644 that is configured to accept as input an STR genotype and to work together with genotype database module 643 to access and search the STR database stored in storage devices 633 for an contributor whose STR genotype matches the input genotype, and to provide as output a positive identification of any such contributor. The input genotype may be provided to search module 644 via user interface 635, but preferably is provided to search module 644 from STR hypothesis system 600 via Internet/network 620.

Although methods 100 and 100′ and system 600 have primarily been described with reference to human contributors, it should be understood that the systems and methods equally may be applied to analysis of DNA in other species. In this regard, it should be noted that no a priori knowledge of the possible genotypes of the contributors at the various STR loci is required, nor is any substantive knowledge about the STR loci themselves. Instead, the present systems and methods equally may be applied to analysis of any suitable number of contributors of any species—including animals (such as horses, mice, and non-human primates), plants (including algae), fungi, or bacteria—whose DNA contains STRs at a plurality of loci that may be translated into data characterizing the relative abundances and sizes of STRs.

For example, it is known that plants have STRs; see, e.g., Gilmore et al., Forensic Science International 131: 65-74 (2003), and Wang et al., TAG Theoretical and Applied Genetics 88: 1-6 (1994). It is also known that fungi have STRs; see, e.g., Geistlinger et al., Molecular and General Genetics MGG 245: 298-305 (1997). It is also known that bacteria have STRs; see, e.g., Zhang et al., Journal of Clinical Microbiology 43: 5221-5229 (2005). It is also known that non-human animals have STRs; see, e.g., Starger et al., Molecular Ecology Resources 8: 619-621 (2008). The present invention is compatible with any species having characterizable STRs at identifiable loci.

### Alternative Embodiment

An alternative embodiment of the present invention provides a system and method for deconvolving individual simple tandem repeat genotypes from DNA samples containing multiple contributors.

The device is comprised of the following:

Please refer to the figure at the end of this example for a key to the reference numbers.

Reference Number—Name of Step
2—Method
4—Sample Lab Processing
6—Allele Calling
8—Number of Contributors
10—Process Significant Cases
12—Score Loci
14—Rank Loci
16—Identify Next Locus
18—Optimize Joint Genotype
20—Loci Remain
22—Significant Cases Remain
24—Return Solution

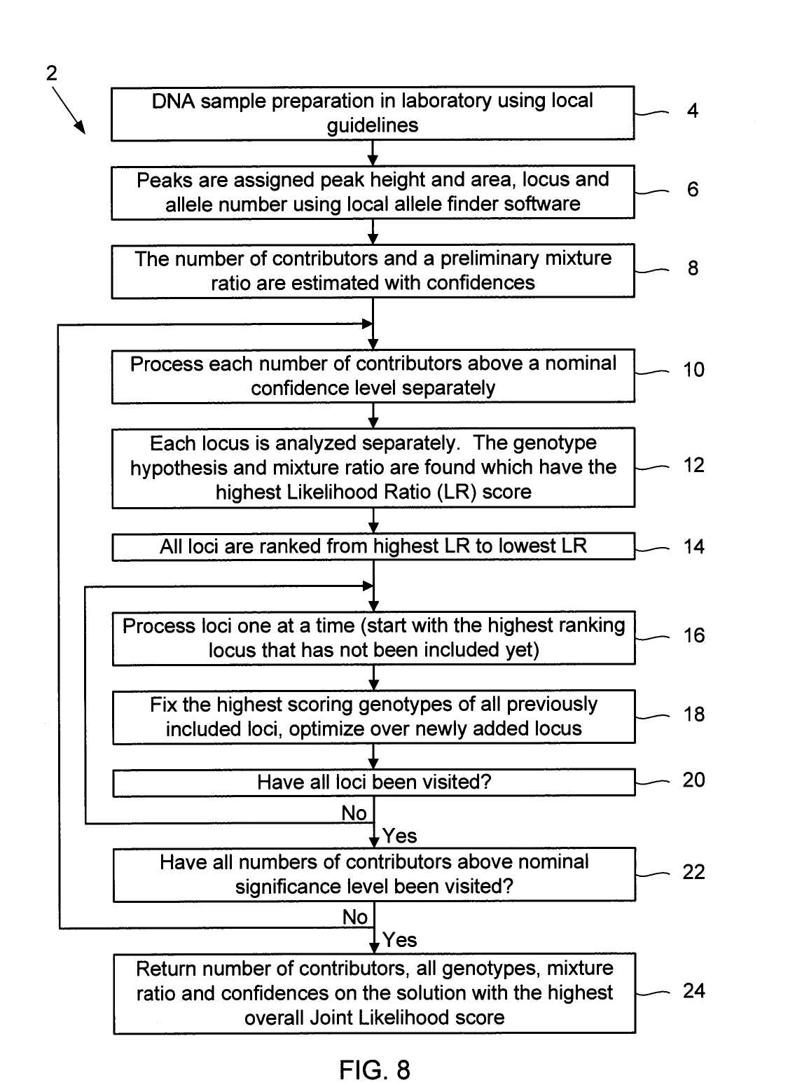

The method 2 illustrated in FIG. 8 describes a method for deconvolving and estimating individual Simple Tandem Repeat (STR) genotypes from a DNA sample containing two or more contributors.

In the step of Sample Lab Processing 4, any existing lab protocols and assays can be used by a lab technician or experimentalist to generate STR trace data. Many different types of lab equipment can be used to generate STR trace data and this method 2 is applicable to trace data generated by any STR assay technology. Technologies commonly used to generate STR assay trace data include capillary gel electrophoresis, DNA sequencing, Polyacrylamide gels, DNA microarrays, and mass spectrometry. All STR assay technologies are used to generate trace data from which the locus, allele number, and peak heights and/or volumes (indicating quantitatively how much is present of each allele in the sample) are estimated by an allele calling software analysis package. The present method 2 can be applied to any such STR assay trace data.

In the step of Allele Calling 6, any existing software analysis program (allele caller) that typically takes in STR trace data and outputs the estimated locus, allele number, and peak heights and/or volumes (indicating quantitatively how much is present of each allele in the sample) for each peak found in the STR trace data can be used by this method 2. Examples of commonly used commercially available software analysis (allele caller) programs which provide these data include Cybergenetics TrueAllele, FSS-i3, and the ABI GeneScan/GenoTyper. This method 2 can use the output data from these as well as any other allele calling software as a foundation to the rest of the method.

In the step of Number of Contributors 8, the joint probability that a given number of contributors produced the observed allele numbers and peak heights and/or volumes found in the STR trace data is calculated for each possible number of contributors. This joint probability is conditioned on the known underlying allele frequencies found in numerous ethnic populations that have been measured and reported by various groups. By virtue of the process used and the fact that it is conditioned on variable ethnic population allele frequencies, the ethnicity of the individuals is also estimated as a result. The calculation gets more complex as the proposed number of contributors increases so the step starts by calculating the probability that one contributor causes the allele distribution found in the STR trace data. It then increases the proposed number of contributors to two and repeats the probability calculation. It then keeps increasing the proposed number of contributors by one and repeats the probability calculation. To bound the problem, as soon as the calculated probability starts decreasing and falls below a user-defined probability threshold, the iterative procedure stops. The confidence, or significance level, assigned to each proposed number of contributors is then calculated by normalizing the probability associated with each proposed number of contributors by the sum of all proposed number of contributors calculated before the iterative procedure stopped.

In the step Process Significant Cases 10, all proposed numbers of contributors that reside above any given input confidence, or significance level, are used to define the size of the hypothesized genotype matrices in the following iterative greedy algorithm (steps 10 through 24) process flow. For example, a confidence, or significance level, that is input by a user of the method 2 is N %. In this example, if a proposed number of contributors of 4 and 5 both have confidences, or significance levels, of higher than N %, the following greedy algorithm outer loop (consisting of steps 10, 12, 14, 16, 18, 20, and 22) would be repeated using the hypothesis of 4 contributors first, and then using the hypothesis of 5 contributors and would be compared in step 24.

In the step Score Loci 12, the proposed number of contributors is fixed and each locus is examined separately in sequential fashion. For each locus, all possible single-locus genotype hypotheses of the fixed number of contributors are used as input to a Maximum Likelihood Estimation (MLE) algorithm which calculates the most likely mixture ratio conditioned on each genotype hypothesis. The Likelihood score for each possible genotype hypothesis and resulting mixture ratio is retained in memory. The locus score is then calculated as a Likelihood Ratio (LR) formed by dividing the Likelihood score from the MLE of the highest scoring genotype by the Likelihood score of the second highest scoring genotype. The resulting LR can then be interpreted as the information present in the locus, i.e., the inherent confidence that the highest scoring genotype hypothesis and resulting mixture ratio are the correct answer. The locus that has the highest information score (LR), i.e., the biggest Likelihood gap between the highest scoring genotype and second-highest scoring genotype, is therefore the one in which there is the most confidence that the resulting genotype hypothesis is the correct one.

In the step Rank Loci 14, the loci scores are taken and sorted from highest to lowest. In order to reduce the genotype hypothesis space, which can become intractable when estimating a genotype across many loci, a greedy algorithm is employed which starts with one locus and iteratively adds subsequent loci until all loci have been included. In order to insure a high-accuracy solution, the loci are ranked in this step in order of information content (LR) so that the loci with the highest information (the loci most likely to provide the correct answer) are used in the greedy algorithm first.

In the step Identify Next Locus 16, any existing genotype solution calculated thus far during iteration of the greedy algorithm is fixed and the next locus that has not been included yet with the highest information content (LR) ranking is identified.

In the step Optimize Joint Genotype 18, the greedy algorithm optimizes the genotype solution by iterative addition of each locus one at a time. On the first iteration the locus with the highest information rank is taken and the most likely genotype and mixture ratio is found. On subsequent iterations, the genotype solution from the previous step is fixed and the most likely genotype and mixture ratio is found using by varying the genotype hypotheses associated with the newly added locus. This process results in loci with less information (lower LR) being estimated conditioned on the genotypes and mixture ratios that are more likely to be accurate (the loci with higher information content). This procedure increases the probability that the genotypes of the lower information loci will be estimated more accurately. If at any point in the iterative cycle the mixture ratio changes more than some user-defined amount, this may indicate that the genotypes estimated earlier in the greedy algorithm were not estimated using an accurate mixture ratio. If this is the case, all previous loci genotypes can be iteratively re-estimated using the current set of fixed genotypes in an attempt to increase the overall likelihood score. This iterative method also allows straightforward calculation of the confidences that the genotypes are estimated accurately for each locus separately. If any of the contributors is of known STR genotype, then one STR genotype is held fixed and equal to that STR genotype thus making the integration of known STR genotypes transparent to the method.

In the step Loci Remaining 20, the decision is made regarding if there are any more loci that have not been included in the joint genotype hypothesis. If all loci have been included in the processing the inner loop of the greedy algorithm (steps 16, 18, and 20) the inner loop is exited and the greedy algorithm continues forward.

In the step Significant Cases Remain 22, the decision is made regarding if there remain any more significant proposed number of contributors that need to be included in the outer loop (steps 10, 12, 14, 16, 18, 20, and 22) of the greedy algorithm. If all proposed number of contributors that reside above the user-defined confidence, or significance level, have been included in the greedy algorithm processing the outer loop is exited and the process continues forward.

In the step Return Solution 24, the solution connected to a given proposed number of contributors with the highest overall Likelihood is judged to be the best solution. The most likely number of contributors, estimated genotypes, mixture ratio, and associated confidences are returned to the user either via a saved report file, sent to a database for archival, or through an on-screen Graphical User Interface (GUI). Information about the other possible solutions are also stored and output if desired for comparison and hands-on analyst examination.

The steps Sample Lab Processing 4 and Allele Calling 6 are necessary in order to generate the quantitative allele data needed as input to the rest of the method. The step Number of Contributors 8 is necessary in order to set the dimensions of the hypothesis STR genotype matrices. Some previous methods skim over this step and thus step Process Significant Cases 10 making it seem optional in this embodiment by starting off the method description assuming the number of contributors is known. This procedure will not scale, however, to the general case where there are many unknown contributors in a DNA sample of unknown constitution. Of course, if there is only one probable number of contributors then step 10 is not needed as the outer loop will iterate only once. The steps Score Loci 12 and Rank Loci 14 similarly can be considered optional because the greedy algorithm can proceed using some heuristic rule for ordering the loci. However, again, leaving out these steps will cause the method to not scale efficiently to larger numbers of contributors because the sheer numbers of hypotheses will cause an abundance of high scoring hypotheses and it will not be obvious which ones are the best solutions statistically. Therefore, for a robust, scalable method these steps are necessary. The inner loop steps 16, 18, and 20 are necessary to the method due to the fact that the method will not scale to many contributors without the inner loop greedy algorithm.

The preferred relationship among elements, including preferred logic and chronological order, is shown in the flow diagram of FIG. 8. The process preferably begins with the step of 4 (Sample Lab Processing) and then step 6 (Allele Calling) which are performed using local guidelines from existing STR genotyping technologies. The novel invention process preferably begins at the step of Number of Contributors 8 and ends at the step of Return Solution 24. As shown in the diagram, the step of Number of Contributors 8 preferably occurs before the step of Process Significant Cases 10, which preferably occurs before the step of Store Loci 12, and so forth. In order to process optimally, the steps need to be addressed in the order given by the flow diagram. Some of the steps can be omitted or altered but will result in degraded performance, as previously mentioned. The initial step Sample Lab Processing 4 is used to process the DNA sample and output STR trace data which typically has some sort of length or mass measure on the x-axis and some abundance or fluorescence on the y-axis. This STR trace data is used as input into the next step Allele Calling 6. Any available STR allele analysis software can be used to generate locus number, allele number, and peak quantitation of each allele peak observed in the STR trace data. The current invention does not attempt to improve on these two steps and as such can use any available lab assays and technologies and allele calling software outputs. The next step Number of Contributors 8 is included in order to set the dimension of the genotype matrices that will be used as genotype hypotheses later in the step Optimize Joint Genotypes 18. Step 8 also generates confidences for the estimated number of contributors so that multiple loops can be performed using different numbers of contributors if it so happens that two different proposed numbers of contributors have a confidence value above some user-defined value.

These confidences are used in the next step Process Significant Cases 10. The step Process Significant Cases 10 defines how many times the outer loop is performed that consists of steps 12, 14, 16, 18, 20, and 22. The result of this outer loop is a mixture ratio estimate and a full STR genotype estimate for all of a given number of contributors. When more than one iteration of the outer loop is performed, the joint likelihoods of the solution for each iteration are compared and the highest overall joint likelihood solution is taken as the final solution and returned. The other solutions can also be returned for final examination by an analyst. Step Significant Cases Remain 22 is the decision step regarding if the outer loop needs to be iterated again or if all significant cases have been included thus exiting to step Return Solution 24. The next steps Score Loci 12 and Rank Loci 14 are used to set the preferential order of adding loci for the greedy algorithm inner loop (steps 16, 18, and 20). In step Score Loci 12 the likelihood Ratio (LR) for each locus as defined above are calculated and then sorted from high LR to low LR in step Rank Loci 14. This ranking is then used as input into the inner loop control step Identify Next Locus 16. The inner loop consisting of steps 16, 18, and 20 is repeated until all loci have been included in the overall STR genotype hypothesis. The step Identify Next Locus 16 fixed the current STR genotype estimate and supplies the next locus to include in the greedy estimation process. This estimate optimization is performed in the next step Optimize Joint Genotype 18. This is followed by the final inner step Loci Remain 20 which is a decision step and dictates whether the inner loop needs to be revisited or if all loci have been included which triggers the exit of the inner loop and allow continuation to step Significant Cases Remain 22 which is the decision step to trigger the exit from the outer loop described above.

The method 2 works as follows. A DNA sample is brought into the lab for analysis which may or may not contain DNA from multiple contributors. The sample is processed using local lab guidelines in step Sample Lab Processing 4. The DNA trace data output from step 4 is used in step Allele Calling 6 to generate quantitative allele data including locus number, allele number, and allele peak volume/height. This quantitative allele data is input into step Number of Contributors 8 which estimates the relative probability of different numbers of contributors being responsible for the allele data observed from the sample. The step Process Significant Cases 10 then initiates the STR genotype estimation outer loop (steps 12, 14, 16, 18, 20, and 22) which is performed for each proposed number of contributors that possess probabilities above a user-defined probability threshold. This genotype estimation outer loop starts with a process which orders the loci in order of information content. Steps Score Loci 12 and Rank Loci 14 perform this information content calculation (step 12) and then rank the loci from high information to low information (step 14). After the loci ranking is complete, step Identify Next Locus 16 controls the inner loop consisting of steps 16, 18, and 20. In step Optimize Joint Genotype 18 the existing and fixed genotype estimation is input along with the set of genotype hypotheses for the newly added locus. The most likely STR genotype for the new locus combined to the existing STR genotype solution is found and then reiterated if step Loci Remain 20 decides there are more loci which need to be included. If all loci have been included the inner loop is exited. The next step Significant Cases Remain 22 decides if there remains any more proposed number of contributors that possess probabilities above the user-defined threshold that need to be processed. If all have been processed the outer loop is exited and the method finishes with the step Return Solution 24.

The method would be used on a computer. The outputs of step Sample Lab processing 4 would be input to the computer via a computer file, for example, a spreadsheet or a database file. The rest of the steps would be integrated into the software and would proceed automatically. At certain points in the process, an analyst could provide input or redirect the process if needed. For example, if in step Allele Calling 6 an obvious STR trace artifact is mistakenly assigned an allele number and peak volume/height, the analyst could interrupt the process, examine the STR trace data, and redefine the artifact as an artifact and not as an allele. The analyst will be able to view the results in step Return Solution 24 either interactively through a Graphical User Interface or after the fact by observing a saved report file or querying a database storing the results.

There are other uses for estimating STR genotypes that are not human. For example, this method could be used for deconvolving mixtures of bacteria and/or viruses using STR genotypes from either environmental or clinical samples.

The invention can be used for analyzing complex mixtures of human DNA that enables rapid STR genotyping of multiple contributors from a DNA sample. The method will allow more actionable intelligence to be obtained from mixed DNA samples collected in the field which is of enormous value to Law Enforcement and other Governmental agencies. Large databases of STR genotypes (like the CODIS database) are stored so that STR genotypes extracted from DNA samples collected at scenes of interest (such as crime scenes) can be matched to known individuals. Previously, DNA samples that contain DNA from many contributors created problems for extracting robust STR genotypes and as such many collected DNA samples were not useful for extracting actionable intelligence by these Government agencies. This invention will allow accurate STR genotyping from these samples and thus increase the information content, actionable intelligence, and overall usefulness of many of these previously unusable DNA samples.

Law enforcement and other Government entities use forensic DNA samples collected at crime scenes or other scenes of interest to estimate the Simple Tandem Repeat (STR) genotypes of the sample contributors and assist the identification of persons who were at the scene and contributed DNA to the sample. These samples often contain DNA from two or more unknown individuals. Sometimes the STR genotypes of one or more of the contributors are known (like a crime victim) which makes the process of estimating the unknown contributors more straightforward. However, if the STR genotypes of 2 or more of the contributors are unknown it can be problematic to estimate their STR genotype accurately due to several practical issues inherent in the genotyping process.

The present invention is novel in that it can deconvolve and estimate unknown STR genotypes from a DNA sample for a large number of contributors (3, 4, or more). These STR genotype estimates are both statistically accurate and the result can be computed in a short amount of computer time.

Current systems that attempt to accurately estimate STR genotypes from STR trace data derived from complex DNA mixtures containing DNA from several individuals run into two major roadblocks: 1) the equations used to generate statistical scores that are then used to estimate the STR genotypes do not accurately contain all relevant noise sources and, 2) the algorithms do not scale readily to larger numbers of contributors in a way that ensures tractable computation of a solution. For example, in case 1) above, there are many performance variance issues that arise in practical STR genotyping processes. These include: uneven amplification of STR amplicons by the Polymerase Chain Reaction (PCR) process; uneven amplification of STR amplicons due to the Poisson statistics which dominate when extracting a liquid aliquot contain small numbers of DNA molecules; stutter effects which are due to PCR amplicon duplication errors; and allele peak drop-in and drop-out effects due again to extracting liquid aliquots when a small amounts of an individual's DNA is present. These effects are frequently ignored (no accounting for Poisson statistics when low-copy number of DNA are present) or sub-optimally included (any peak with a peak height less than 20% of the tallest peak is considered stutter and thrown out). The best results will occur from all of these effects being correctly included in the statistical score equations. The current method 2 includes all of the performance variance issues correctly in its statistical score equations. In support of case 2) above, the fact is noted that existing methods do not claim and/or demonstrate cases where deconvolution and STR genotype estimation from a complex DNA mixture of 4 or more contributors is shown. The current method invokes a greedy algorithm that scans the solution space very quickly and can produce STR genotype estimates from mixed DNA samples of two or more contributors in very short amounts of time (minutes). This ability has been readily demonstrated.

In one illustrative embodiment, a method is provided for deconvolving individual Simple Tandem Repeat genotypes from DNA samples containing multiple contributors.

The present invention solves this problem through a novel signal processing system which possesses two critical features: 1) the STR genotype solution presented is statistically accurate, and 2) the solution can be arrived at in a short amount of computer processing time. For DNA samples containing few contributors there are other deconvolution techniques that produce a reasonable solution. However, for DNA samples containing 3, 4, or more contributors, the set of possible STR genotype hypotheses is overwhelming and existing techniques do not scale to the higher complexity. The present invention scales smoothly to these higher levels of complexity retaining both statistical accuracy and tractable computation times.

### EXAMPLES

Method 100 illustrated above was implemented as a computer algorithm using the programming language MATLAB (MathWorks, Natick, Mass.) on a standard laptop computer, using formats and methods for obtaining the STR traces (and peak identification thereof), ranges of abundance ratios, hypothetical STR genotypes, sets of simulated STR peaks (and comparison thereof to the STR traces), and outputs analogous to those respectively described above with reference to Tables 1-9 described above. The laptop used was a LENOVO® Model T510 personal computer (Lenovo Group Limited, Morrisville, N.C.), which included an 1-7 CPU (Intel Corporation, Santa Clara, Calif.), running at 2.67 GHz, that used the 64 bit version of the WINDOWS® 7 operating system (Microsoft Incorporated, Redmond, Wash.) and had 8 Gb of RAM.

FIGS. 7A-7D illustrate an exemplary graphical user interface that was generated using the above-described computer algorithm implemented in MATLAB, and displayed on the screen of the laptop computer, that includes the algorithm's output based on the input of STR traces for simulated DNA samples having contributions from different numbers of contributors.

Turning first to FIG. 7A, GUI 701 includes a file selection interface 721 via which a user may input the name of a file that contains the STR traces for a nucleic sample having contributions from a plurality of contributors; a “plot the traces” command button 731 for plotting the STR traces 711 contained in the file, each trace 711 including STR peaks 711′; a “call alleles” command button 741 for obtaining and plotting the allele call 711″ corresponding to each of the STR peaks 711′; a “determine # of contributors” command button 751 for causing the algorithm to determine the most likely number N of contributors to the sample (in this specific example, based on population statistics such as described above with reference to FIG. 3B); an “are there any known contributor genotypes?” command button 761 for accepting a “yes” or “no” answer, and if the answer is “yes,” causing the interface to provide an additional file selection interface (not shown) similar to that of interface 721 via which a user may input the name of a file containing STR traces for a DNA sample having contribution(s) from any known contributor(s); a “genotype sample” command button 771 for causing the interface to obtain, select, and display a solution in output area 791 for the sample, including based on other hypothetical numbers N′ of contributors; and a “determine if a known genotype is present” command button 781 for causing the algorithm to compare the contributors' most likely STR genotypes of the joint genotype hypothesis to stored STR genotypes so as to positively identify any known contributors.

As may be seen in FIG. 7A, the displayed joint genotype hypothesis output area 791 includes an output area 795 for displaying the estimated number of contributors in the sample; an output area 796 for displaying the confidence on the number of contributors; an output area 797 for displaying the abundance ratio of their respective contributions to the DNA sample; and a genotype report 798 for displaying the most likely STR genotypes at each of the loci for each of the contributors, here in the form of allele calls at each of the loci. It will be appreciated that the particular inputs, outputs, and command buttons included in GUI 701 suitably may be modified.

In the example illustrated in FIG. 7A, the STR file that was input into the algorithm via file selection interface 721 included a mixture of simulated STR genotypes of two contributors having STR peaks at fifteen loci referred to in the art as CSF1PO, FGA, TH01, TPOX, VWA, D3S1358, D5S818, D7S820, D8S1179, D13S317, D16S539, D18S51, D21S11, D2S1338, and D19S433. The simulated STR genotypes of contributors 1 and 2, in the allele call format, are listed in Table 10, and the respective abundance ratio thereof was 70:30. By comparing the two contributors' simulated STR genotypes listed in Table 10 to the corresponding most likely STR genotypes that the algorithm obtained and displayed in output area 791 in FIG. 7A, it may be seen that the algorithm was 100% accurate in obtaining contributor 1's STR genotype, and that the algorithm was 93% accurate in obtaining contributor 2's STR genotype, with a single error at each of the TH01 and D5S818 loci. It also may be seen in the output area 791 in FIG. 7A that the algorithm identified the abundance ratio as being 70:30 with a confidence of 100% that there were two contributors.

TABLE 10
Simulated STR Genotypes Used as Input in Example of FIG. 7A

| | Contrib- | Contrib- |
|---|---|---|
| Locus | utor 1 | utor 2 |
| CSF1PO | 13 13 | 10 11 |
| FGA | 28 33 | 31 31 |
| TH01 | 3 7 | 7 7 |
| TPOX | 4 10 | 6 8 |
| VWA | 21 23 | 15 19 |
| D3S1358 | 19 21 | 17 19 |
| D5S818 | 10 11 | 11 13 |
| D7S820 | 8 13 | 6 10 |
| D8S1179 | 11 13 | 10 15 |
| D13S317 | 10 11 | 6 11 |
| D16S539 | 10 11 | 10 11 |
| D18S51 | 17 19 | 17 17 |
| D21S11 | 42 52 | 42 48 |
| D2S1338 | 33 35 | 27 37 |
| D19S433 | 11 19 | 11 19 |

In the example illustrated in FIG. 7B, the STR file that was input into the algorithm via file selection interface 721 included a mixture of simulated STR genotypes of three contributors having STR peaks at the same fifteen loci as for the example illustrated in FIG. 7A. The simulated STR genotypes of contributors 1, 2, and 3, again in the allele call format, are listed in Table 11, and the respective abundance ratio thereof was 70:20:10. By comparing the three contributors' simulated STR genotypes listed in Table 11 to the corresponding most likely STR genotypes that the algorithm obtained and displayed in output area 791, it may be seen that the algorithm was 100% accurate in obtaining contributor l's STR genotype, was 83% accurate in obtaining contributor 2's STR genotype, with a single error at each of the CSF1PO, VWA, D3S1358, D8S1179, and D21S11 loci, and was 77% accurate in obtaining contributor 3's STR genotype, with a single error at each of the FGA, TH01, D5S818, D8S1179, D16S539, D18S51, and D21S11 loci. It also may be seen in the output area 791 in FIG. 7B that the algorithm identified the abundance ratio as being 70:19:11 with a confidence of 100% that there were three contributors.

TABLE 11
Simulated STR Genotypes Used as Input in Example of FIG. 7B

| | Contrib- | Contrib- | Contrib- |
|---|---|---|---|
| Locus | utor 1 | utor 2 | utor 3 |
| CSF1PO | 10 11 | 10 11 | 8 11 |
| FGA | 27 28 | 25 27 | 28 34 |
| TH01 | 2 2 | 2 4 | 4 7 |
| TPOX | 4 10 | 4 10 | 4 10 |
| VWA | 19 21 | 13 21 | 21 23 |
| D3S1358 | 17 23 | 15 17 | 19 23 |
| D5S818 | 10 11 | 10 10 | 10 10 |
| D7S820 | 8 10 | 3 10 | 10 10 |
| D8S1179 | 15 17 | 11 15 | 11 15 |
| D13S317 | 10 11 | 10 10 | 15 17 |
| D16S539 | 10 13 | 6 6 | 6 10 |
| D18S51 | 15 19 | 11 19 | 10 19 |
| D21S11 | 46 49 | 42 47 | 41 44 |
| D2S1338 | 25 33 | 35 37 | 27 37 |
| D19S433 | 15 19 | 13 15 | 13 15 |

In the example illustrated in FIG. 7C, the STR file that was input into the algorithm via file selection interface 721 included a mixture of simulated STR genotypes of four contributors having STR peaks at the same fifteen loci as for the example illustrated in FIG. 7A. The simulated STR genotypes of contributors 1, 2, 3, and 4, again in the allele call format, are listed in Table 12, and the respective abundance ratio thereof was 60:20:15:5. By comparing the four contributors' simulated STR genotypes listed in Table 12 to the corresponding most likely STR genotypes that the algorithm obtained and displayed in output area 791, it may be seen that the algorithm was 97% accurate in obtaining contributor 1's STR genotype. The algorithm was 67% accurate in obtaining contributor 2's STR genotype, with single errors at each of the CSF1PO, TH01, D7S820, D8S1179, D13S317, D18S51, D2S1338, and D19S433 loci, and two errors at the VWA locus. The algorithm was 53% accurate in obtaining contributor 3's STR genotype, with single errors at each of the TH01, TPOX, VWA, D2S1358, D7S820, D8S1179, D13S317, D18S51, D21S11, and D2S1338 loci, and two errors at each of the CSF1PO and D19S433 loci. The algorithm was 57% accurate in obtaining contributor 4's STR genotype, with single errors at each of the TPOX, VWA, D3S1358, D7S820, D13S317, D21S11, and D19S433 loci, and two errors at each of the CS1FPO, D8S1179, and D2S1338 loci. It also may be seen in the output area 791 in FIG. 7C that the algorithm identified the abundance ratio as being 60:18:14:8 with a confidence of 68% that there were four contributors.

TABLE 12
Simulated STR Genotypes Used as Input in Example of FIG. 7C

| | Contrib- | Contrib- | Contrib- | Contrib- |
|---|---|---|---|---|
| Locus | utor 1 | utor 2 | utor 3 | utor 4 |
| CSF1PO | 10 11 | 8 11 | 10 13 | 11 11 |
| FGA | 28 37 | 30 30 | 23 35 | 28 33 |
| TH01 | 2 6 | 4 6 | 6 7 | 6 7 |
| TPOX | 4 8 | 4 4 | 6 10 | 4 10 |
| VWA | 15 25 | 17 21 | 15 23 | 19 23 |
| D3S1358 | 17 17 | 19 19 | 15 17 | 21 23 |
| D5S818 | 10 10 | 11 11 | 11 13 | 10 10 |
| D7S820 | 6 10 | 10 11 | 4 8 | 10 11 |
| D8S1179 | 8 11 | 8 11 | 13 13 | 11 11 |
| D13S317 | 10 13 | 10 15 | 4 13 | 10 13 |
| D16S539 | 10 11 | 10 11 | 11 11 | 11 11 |
| D18S51 | 19 21 | 11 15 | 13 19 | 15 17 |
| D21S11 | 41 52 | 44 46 | 44 46 | 46 47 |
| D2S1338 | 21 35 | 21 27 | 27 37 | 27 27 |
| D19S433 | 13 15 | 13 17 | 11 11 | 13 15 |

In the example illustrated in FIG. 7D, the STR file that was input into the algorithm via file selection interface 721 included a mixture of simulated STR genotypes of four contributors having STR peaks at the same fifteen loci as for the example illustrated in FIG. 7A. The simulated STR genotypes of contributors 1, 2, 3, and 4, again in the allele call format, are listed in Table 13, and the respective abundance ratio thereof was 25:15:50:10. In this example, the contributors 1 and 2 were treated as “known” contributors by separately inputting their corresponding STR genotypes into the algorithm via the “are there any known genotypes?” command button 761 and entering file names containing those STR genotypes. The algorithm then proceeded in accordance with the modified method 100′ illustrated in FIG. 5. By comparing the four contributors' simulated STR genotypes listed in Table 13 to the corresponding most likely STR genotypes that the algorithm obtained and displayed in output area 791, it may be seen that the algorithm was 100% accurate in obtaining the STR genotypes not only of contributors 1 and 2, as would be expected because those genotypes were input as “known,” but also that of contributor 3. The algorithm was 87% accurate in obtaining the STR genotype of contributor 4, with a single error at each of the VWA, D5S1358, D13S317, and D16S539 loci. It also may be seen in the output area 791 in FIG. 7D that the algorithm identified the abundance ratio as being 27:15:47:11 with a 90% confidence that there were four contributors.

TABLE 13
Simulated STR Genotypes Used as Input in Example of FIG. 7D

| | Contrib- | Contrib- | Contrib- | Contrib- |
|---|---|---|---|---|
| Locus | utor 1 | utor 2 | utor 3 | utor 4 |
| CSF1PO | 10 11 | 10 11 | 11 11 | 8 13 |
| FGA | 28 37 | 30 30 | 25 28 | 27 33 |
| TH01 | 2 7 | 6 7 | 2 7 | 2 6 |
| TPOX | 4 4 | 4 4 | 4 10 | 4 10 |
| VWA | 21 21 | 17 25 | 21 23 | 19 21 |
| D3S1358 | 19 19 | 19 21 | 15 19 | 21 21 |
| D5S818 | 11 11 | 11 11 | 10 13 | 10 11 |
| D7S820 | 10 10 | 8 10 | 3 8 | 4 8 |
| D8S1179 | 11 17 | 13 15 | 13 13 | 8 11 |
| D13S317 | 8 11 | 8 15 | 10 11 | 10 11 |
| D16S539 | 6 11 | 6 6 | 10 11 | 10 11 |
| D18S51 | 17 17 | 11 15 | 11 13 | 15 21 |
| D21S11 | 44 46 | 42 44 | 44 46 | 44 45 |
| D2S1338 | 25 33 | 30 35 | 21 25 | 27 33 |
| D19S433 | 15 17 | 17 19 | 13 15 | 11 13 |

To assess the rapidity with which the above-described laptop running the above-described algorithm implemented in MATLAB could obtain the most likely STR genotypes for different numbers of individuals who contributed to a DNA sample, simulations such as those described above with reference to FIGS. 7A-7C were repeated dozens of times for varying numbers of contributors, including varying numbers of known contributors, and the time it took to obtain those contributors' most likely STR genotypes was recorded. Table 14 shows the average amount of time that it took the algorithm to obtain different numbers of contributors' most likely STR genotypes. It may be seen from Table 14 that even for the most complex combination tested, that of four unknown contributors with no known contributors, it took an average of 447 seconds, or about 7.5 minutes, to obtain the most likely STR genotype of each of those contributors. It should be noted that the algorithm suitably may be implemented in other programming languages that may provide such an output even more quickly than could MATLAB, and that a faster computer of course could be used. However, even using the above-described exemplary setup, it may be seen that it is practicably feasible to obtain STR genotypes for four or more contributors using the systems and methods of the present invention.

TABLE 14
Average Actual Times for Obtaining Most Likely of Different Numbers
of Contributors Using Inventive Method on Laptop Computer

| No. of Known | Two Contributor | Three Contributor | Four Contributor | |
|---|---|---|---|---|
| Contributors | Mixture | Mixture | Mixture | |
| 0 | 2 seconds | 47 seconds | 447 | seconds |
| 1 | 1 second | 6 seconds | 256 | seconds |
| 2 | N/A | 2 seconds | 18 | seconds |
| 3 | N/A | N/A | 3 | seconds |

By comparison, a “brute force” method in which the greedy algorithm described herein was not used and in which the different contributors' STR genotypes instead were obtained by generating a full range of hypothetical STR genotypes for each contributor, at each locus, in each possible abundance ratio, would be expected to take significantly longer. Indeed, the amount of computer time scales as N^{L}, where N is the number of contributors and L is the number of loci (e.g., 13 for CODIS), and thus would be expected to be computationally intractable, that is, not practicably feasible to implement even using a supercomputer. Table 15 lists the estimated times for obtaining most likely STR genotypes for different numbers of contributor, using the “brute force” method on the above-described laptop computer. It may be seen from Table 1 that for the most complex combination tested, that of four unknown contributors with no known contributors, it is estimated that it would take 10⁴⁸ years to obtain the most likely STR genotype of each of those contributors. Thus, it may be seen that the systems and methods of the present invention are many orders of magnitude faster than a “brute force” method.

TABLE 15
Estimated Times for Obtaining Most Likely STR Genotypes
of Different Numbers of Contributors Using “Brute
Force” Method on Laptop Computer

| No. of Known | Two Contributor | | Three Contributor | | Four Contributor |
|---|---|---|---|---|---|
| Contributors | Mixture | | Mixture | | Mixture |
| 0 | 10⁵ | years | 10²⁴ | years | 10⁴⁸ years |
| 1 | 3467 | seconds | 10¹¹ | years | 10³² years |

| | | | | |
|---|---|---|---|---|
| 2 | N/A | 2 | years | 10¹⁶ years |

| | | | |
|---|---|---|---|
| 3 | N/A | N/A | 876 years |

Additionally, to assess the accuracy with which the above-described laptop running the above-described algorithm implemented in MATLAB could obtain most likely STR genotypes for different numbers of contributors who contributed to a DNA sample, simulations such as those described above with reference to FIGS. 7A-7C were repeated dozens of times for varying numbers of contributors, including varying numbers of known contributors, and the time it took to obtain those contributors' most likely STR genotypes was recorded. Table 14 shows the average percentage of each contributors' most likely STR genotype that the algorithm correctly obtained (e.g., at what percentage of the loci did the algorithm correctly identify the contributor's STR genotype). It may be seen from Table 16 that even for the most complex combination tested, that of four unknown contributors with no known contributors, the most likely STR genotype of each of those contributors was obtained with an average 73.7% accuracy. In this regard, it should be noted that even although such accuracy is somewhat lower than for other combinations of contributors, if the STR loci are the 13 CODIS loci, a 73% match between a most likely STR genotype and an actual contributor's genotype in the CODIS database would occur randomly at a probability of less than 1 in 100 trillion. As such, the systems and methods of the present invention provide an extremely high confidence in any match found between a most likely STR genotype and that of a known contributor in an STR database such as CODIS.

TABLE 16
Average Accuracy of Most Likely STR Genotypes of Different Numbers
of Contributors Using Inventive Method on Laptop Computer

| No. of Known | Two Contributor | Three Contributor | Four Contributor |
|---|---|---|---|
| Contributors | Mixture | Mixture | Mixture |
| 0 | 98.5% | 76.8% | 73.7% |
| 1 | 99.9% | 93.9% | 90.1% |
| 2 | N/A | 99.5% | 96.8% |
| 3 | N/A | N/A | 98.6% |

Various references, such as patents, patent applications, and publications are cited herein, the disclosures of which are hereby incorporated by reference herein in their entireties.

As used herein, the term “a” is not intended to be limiting; that is, “a” does not necessarily mean only one.

While various illustrative embodiments of the invention are described above, it will be apparent to one skilled in the art that various changes and modifications may be made therein without departing from the invention. The appended claims are intended to cover all such changes and modifications that fall within the true spirit and scope of the invention.

What is claimed:

1. A method for analyzing a mixture of DNA from two or more contributors to identify the STR genotypes of at least one of said contributors at a plurality of STR loci, the method comprising:
(a) for each STR locus in said plurality of STR loci, independently determining a plurality of possible solutions for said STR locus and the confidence score for each of the possible solutions given data characterizing the relative abundances and sizes of STRs in said mixture at that locus, each solution comprising:
(i) a defined number N of contributors,
(ii) a defined STR genotype for each of the N contributors at that locus, and
(iii) a defined abundance ratio of respective contributions from the N contributors;
(b) for the STR locus having the highest confidence score, selecting one or more possible solutions for that locus that have a likelihood above a threshold value;
(c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value;
(d) repeating step (c) serially for each remaining STR locus in descending order of confidence score given the defined number N and the defined abundance ratio of the possible solutions for the immediately previously analyzed STR locus; and
(e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

2. The method of claim 1, further comprising obtaining the defined number N of contributors prior to executing step (a).

3. The method of claim 2, wherein the defined number N of contributors is obtained based on population statistics.

4. The method of claim 2, further comprising:
(f) obtaining a new defined number N′ of contributors;
(g) repeating steps (a) through (d) given the new defined number N′ of contributors; and
(h) outputting the STR genotype for the most likely selected solution of step (g) for the last STR locus analyzed and the STR genotype for each selected solution for each previously analyzed STR locus that shares as a given the new defined number N′ of contributors and the defined abundance ratio used to determine the most likely selected solution of step (g) for the last STR locus.

5. The method of claim 2, wherein the defined number N of contributors is obtained by determining how many STRs are present in the data at each locus, and by defining the number N of contributors to be the minimum number of individuals who could have contributed to the DNA sample given how many STRs are present in the data at the locus having the most STRs in the data.

6. The method of claim 1, wherein step (a) comprises:
(i) defining a range of hypothetical abundance ratios of contributions of the defined number N of contributors;
(ii) for each STR locus, defining a set of hypothetical STR genotypes at that locus that is consistent with the defined number N of contributors and with the data characterizing the sizes of the STRs at that locus; and
(iii) for each STR locus, determining the plurality of possible solutions based on the set of hypothetical STR genotypes for that locus defined in step (a)(ii) and in the different hypothetical abundance ratios defined in step (a)(i).

7. The method of claim 6, wherein step (a) further comprises:
(iv) for each STR locus, comparing each solution from step (a)(iii) for that locus to the data characterizing the abundances and sizes of the STRs at that locus to obtain the likelihood of that solution; and
(v) for each STR locus, analyzing the likelihoods of the solutions for that locus to obtain the confidence score of that STR locus.

8. The method of claim 7, wherein analyzing the likelihoods of the solutions in step (a)(v) comprises obtaining a likelihood ratio for each solution by dividing the likelihood of that solution by the likelihood of the next most likely solution.

9. The method of claim 7, wherein analyzing the likelihoods of the solutions in of step (a)(v) comprises determining the sparsity of the distribution of likelihoods for each locus.

10. The method of claim 7, wherein analyzing the likelihoods of the solutions in of step (a)(v) comprises determining the kurtosis of the distribution of likelihoods for each locus.

11. The method of claim 1, wherein each contributor has an unknown STR genotype prior to performing said method.

12. The method of claim 1, wherein a mixture of DNA from two to four human contributors is analyzed.

13. The method of claim 12, wherein two, three, or four of the human contributors have unknown STR genotypes prior to performing said method.

14. The method of claim 1, wherein a mixture of DNA from three or four human contributors is analyzed.

15. The method of claim 14, wherein three or four of the human contributors have unknown STR genotypes prior to performing said method.

16. The method of claim 1, wherein a mixture of DNA four human contributors is analyzed.

17. The method of claim 16, wherein each of the four human contributors have unknown STR genotypes prior to performing said method.

18. The method of claim 1, wherein the possible solutions determined in step (a) comprise solutions for each separate instance of N being 2, 3, or 4.

19. The method of claim 1, wherein the possible solutions for each locus are constrained by the sizes of STRs in said mixture at that locus.

20. The method of claim 1, wherein the STR genotype output in step (e) comprises the STR genotypes for the contributor that has the most abundant DNA in said mixture.

21. The method of claim 1, further comprising outputting the likelihood for said outputted STR genotypes.

22. The method of claim 1, further comprising (i) comparing the outputted STR genotypes to a database storing sets of STR genotypes present in human individuals and the identities of the corresponding individuals and (ii) outputting the identity of the human individual whose set of STR genotypes is most likely to match the outputted STR genotypes.

23. A computer-based system configured to identify at least one individuals' STR genotype at a plurality of loci in a DNA sample having a mixture of a plurality of individuals' STR genotypes at the plurality of loci, the computer-based system comprising:
a processor;
a display device in operable communication with the processor; and
a computer-readable storage medium in operable communication with the processor, the computer-readable storage medium configured to store instructions for causing the processor to execute the following steps:
(a) for each STR locus in said plurality of STR loci, independently determining a plurality of possible solutions for said STR locus and the confidence score for each of the possible solutions given data characterizing the relative abundances and sizes of STRs in said mixture at that locus, each solution comprising:
(i) a defined number N of contributors,
(ii) a defined STR genotype for each of the N contributors at that locus, and
(iii) a defined abundance ratio of respective contributions from the N contributors;
(b) for the STR locus having the highest confidence score, selecting one or more possible solutions for that locus that have a likelihood above a threshold value;
(c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value;
(d) repeating step (c) serially for each remaining STR locus in descending order of confidence score given the defined number N and the defined abundance ratio of the possible solutions for the immediately previously analyzed STR locus; and
(e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

24. A computer-readable medium configured for use by a computer-based system to identify at least one individuals' STR genotype at a plurality of loci in a DNA sample having a mixture of a plurality of individuals' STR genotypes at the plurality of loci, the computer-based system comprising a processor, and a display device in operable communication with the processor, the computer-readable medium comprising instructions for causing the processor to execute the following steps:
(a) for each STR locus in said plurality of STR loci, independently determining a plurality of possible solutions for said STR locus and the confidence score for each of the possible solutions given data characterizing the relative abundances and sizes of STRs in said mixture at that locus, each solution comprising:
(i) a defined number N of contributors,
(ii) a defined STR genotype for each of the N contributors at that locus, and
(iii) a defined abundance ratio of respective contributions from the N contributors;
(b) for the STR locus having the highest confidence score, selecting one or more possible solutions for that locus that have a likelihood above a threshold value;
(c) for an STR locus having the next highest confidence score, analyzing that locus by (i) determining a plurality of possible solutions for said STR locus given the data and given the defined number N and the defined abundance ratio of the selected one or more solutions for the STR locus having the highest confidence score and by (ii) selecting one or more solutions for that locus that have a likelihood above the threshold value;
(d) repeating step (c) serially for each remaining STR locus in descending order of confidence score given the defined number N and the defined abundance ratio of the possible solutions for the immediately previously analyzed STR locus; and
(e) outputting the STR genotype for the most likely selected solution for the last analyzed STR locus analyzed and the STR genotype of each selected solution for each previously analyzed STR locus that shares as a given the defined number N and the defined abundance ratio used to determine the most likely selected solution for the last analyzed STR locus.

25. A method for deconvolving individual simple tandem repeat (STR) genotypes from DNA samples containing multiple contributors, the method comprising:
(a) estimating the likely numbers of contributors and a preliminary mixture ratio for each likely number of contributors;
(b) for a first likely number of contributors, separately analyzing each STR locus to obtain a genotype hypothesis score and mixture ratio having the highest likelihood ratio (LR) score;
(c) ranking the loci in descending order of LR score;
(d) starting with the highest ranking locus that has not yet been included, process each locus one at a time in descending order of LR score, the processing for each locus comprising obtaining the most likely solution for that locus fixing the solutions for all previously processed loci, if any;
(e) repeating steps (b) through (d) for other likely numbers of contributors, if any; and
(f) returning the number of contributors, those contributors' STR genotypes, the mixture ratio, and the confidences for the solution with the highest overall likelihood.
